(19) United States
(12) Patent Application Publication
(10) Pub. No.: US 2026/0044812 A1
(43) Pub. Date: Feb. 12, 2026

(54) METHOD FOR TRACKING SHIPMENTS OR TRANSPORT CONTAINERS AND TRACKING DEVICE

(71) Applicant: POSTAL CONSULTING Rühl GmbH, Berlin (DE)

(72) Inventor: Steffen RÜHL, Berlin (DE)

(73) Assignee: POSTAL CONSULTING Rühl GmbH, Berlin (DE)

(21) Appl. No.: 19/101,145

(22) PCT Filed: Aug. 4, 2023
(86) PCT No.: PCT/EP2023/071732

§ 371 Date: Feb. 4, 2025

(30) Foreign Application Priority Data
Aug. 5, 2022 (EP) 22189069.2

(51) Int. Cl. G06Q 10/0833; G06Q 10/087

(52) U.S. Cl. CPC G06Q 10/0833; G06Q 10/08774

(57) ABSTRACT

The present disclosure provides a method for tracking shipments or transport containers and tracking device. In one example, the method includes the transport of a shipment from a first user to a recipient can be tracked using a tracking device which is enclosed with the shipment. After the shipment has reached the recipient, a destination address instruction is transmitted to the tracking device by a control unit, which causes destination address information to be displayed on a graphic output unit of the tracking shipment for onward transmission of the tracking device to a second user. The control unit monitors the stock level of the tracking devices at the users, wherein the control unit determines the destination instruction according to the demand for tracking devices by the users and/or according to the stock level of tracking devices at the users.

### TECHNICAL BACKGROUND

The present invention is in the field of movement of goods and logistics and relates to a method for tracking shipments or transport containers, and a tracking device.

In the movement of goods, senders, carriers (hauliers) and recipients have a great interest in receiving or being able to query information about the shipping status and current position of shipments on a repeated or continuous basis. Typically, a sender hands over a shipment addressed to the recipient to the carrier, who then transports this shipment to the recipient. In normal commercial transactions, the carrier may also be several carriers, for example subcontractors. For the sake of simplicity, this description often only refers to a carrier who transports the shipment to its destination.

The sender often wants to provide the recipient with a high level of transparency regarding the shipment status. To this end, the sender links the tracking systems of the carrier(s), which then physically transport the shipment to the recipient, to their own CRM (Customer Relationship Management) systems in order to provide the recipient with as much up-to-date information as possible about the packaging and shipping status.

Carriers (hauliers) have an interest in providing up-to-date information on the shipping status, as this increases the satisfaction of senders and recipients. This also helps to avoid costs that would otherwise be incurred, e.g. for queries in the call centre. However, carriers often use systems that do not always work in real time. Such systems often use the localisation capability of transport vehicles to determine the position of the shipments transported by the transport vehicles.

It is very important for the recipient to know the shipping status and the likely delivery time. Certain actions can be derived from this for commercial or private recipients. A private recipient can make a better decision as to when they should be at home to receive the shipment. For a commercial recipient, the receipt of a shipment can possibly trigger further internal processes, such as preparing a repair at a customer's premises, as the spare part sent with the shipment will soon be delivered.

The tracking of a shipment is generally described as tracking. In some cases, trackers are used, i.e. devices that are attached to the shipment and allow the location of the shipment to be queried at any time. However, such trackers are quite expensive, so they are only used if the value of the shipment justifies it. Furthermore, it is necessary to trace the trackers. This is cumbersome and associated with high costs. Trackers are therefore only very rarely added to a shipment.

US 2018/0012177 A1 describes a tracker that has a communication unit for receiving addresses and a display for showing the addresses. After the tracker has been used, it receives the address of the nearest distribution centre so that the provider of the tracker can prepare it for the next use.

WO 2012/045 182 A1 discloses a tracker comprising a communication unit and a confirmation unit. After the shipment with the tracker has arrived at the recipient, the recipient confirms receipt by actuating the confirmation unit. The confirmation is then transmitted to the transmitter.

Other solutions that use trackers are known from US 2020/0051015 A1, WO 2019/232314 A1, US 2019/0190550 A1, US 2017/0161679 A1, GB 2546288 A, EP 2827287 A1, EP 2497056 B1, US 2005/0116047 A1, EP 1697811 B1, and WO 2019/102390 A1.

### SUMMARY OF THE INVENTION

With this in mind, a method according to any one of claims 1, 16 or 19, and a tracking device according to any one of claims 18, 21 or 22 are proposed.

According to one embodiment, a method is proposed for tracking shipments such as postal, parcel, package, forwarding and courier shipments and for redistributing tracking devices. In the method, a plurality of users are each provided with at least one tracking device, preferably a plurality of tracking devices, which each have a communication module and a graphic output unit and which can communicate or are in connection with a control unit wirelessly via the communication module independently of one another. One of the tracking devices is activated for use by a first one of the plurality of users to track a shipment from the first user to a recipient, to send the activated tracking device together with the shipment to the recipient. The activation of the tracking device is transmitted (forwarded) to the control unit. The control unit repeatedly receives the position of the activated tracking device during the transport of the shipment to the recipient. The first user and/or the recipient can track the position of the shipment via the control unit. The control unit monitors the stock level of the tracking devices at some or all of the users and transmits destination instructions to the activated tracking device after it has arrived at the recipient together with the shipment, which causes destination address information to be displayed on the graphic output unit for onward transmission to a second of the plurality of users. The destination instructions are determined by the control unit depending on (as a function of) the demand for tracking devices by the users and/or depending on (as a function of) the stock level of tracking devices at the users.

According to a further embodiment, which can be implemented alone or in any combination with any other embodiment described herein, a tracking device for tracking shipments or transport containers has a flat base body with two opposite side surfaces. The flat base body preferably has minimum dimensions of 7 cm×10 cm and in particular of 9 cm×14 cm, wherein the length is preferably at least 1.4 times the width, and wherein the flat base body preferably has a thickness of no more than 1 cm and in particular no more than 0.5 cm. The tracking device further comprises a graphic output unit integrated into one of the two side surfaces; a communication module (first communication module) to establish wireless communication with a communication network; a near-field communication module (second communication module) to communicate contactlessly with an operator device; optionally a short-range communication module (third communication module); a memory module; at least two sensors selected from a light sensor, an acceleration sensor (accelerometer), bending sensor and a rotation rate sensor (gyrometer); a processor module; a rechargeable energy source; and an identifier in the form of a machine-readable code; wherein the communication module, the near-field communication module, the optional short-range communication module, the memory module, the at least two sensors, the processor module, and the rechargeable energy source are integrated into the flat base body.

The tracking device is particularly suitable for the methods described below and is adapted accordingly.

An advantage of the present invention is the user-friendly tracking of the shipments for the users and recipients as well as the very efficient distribution and provision of tracking devices to the users who use the tracking devices for tracking shipments to recipients, for example. The recipients can also be users who in turn use tracking devices to track shipments, or end customers who merely forward or return the tracking devices. For the purposes of this application, a user is a person, company or institution that uses tracking devices to track shipments and attaches a tracking device to each shipment or a selected shipment or several selected shipments. The tracking devices are provided to the users, whereby the number of tracking devices provided may vary from user to user. Among the users, at least one tracking device may be provided to at least one user and a plurality of tracking devices may be provided to other users.

A shipment is understood to mean, in particular, consignments of goods such as parcels, small packages and courier shipments, but also larger deliveries of goods that are large enough to accommodate a tracking device. However, shipments can also be ‘simple’ postal items such as letters, which would otherwise have been sent using the ‘registered mail’ additional service, for example.

According to one aspect of the present invention, the distribution of the tracking devices to the users is monitored and controlled by the control unit. To this end, the control unit monitors, for example, the stock levels of tracking devices at some or all of the users, in particular at the users to each of which a plurality of tracking devices have been provided. The use of the tracking devices by the users, for example to track a specific shipment to a recipient, reduces the stock level at the respective user. These users may therefore have a need for additional tracking devices in order to increase the stock level and always have sufficient tracking devices available. The needs of individual users can vary greatly and be subject to fluctuations. For example, one user regularly sends a large number of shipments and would like to monitor their progress using the tracking devices. This user therefore always has a need for many tracking devices. Another user sends shipments rather irregularly, whereby it can happen that many shipments are sent at short notice. This user therefore has a fluctuating need for tracking devices. Users can adjust their tracking device demand and transmit them to the control unit, for example.

Since the control unit monitors the stock levels of each individual user, the distribution of the tracking devices can be controlled in a targeted manner by means of the control unit and, in particular, can also be carried out in advance. For example, when a user adds a tracking device to a shipment, the tracking device is activated beforehand. The activation is registered by the control unit. Similarly, the dispatch of the tracking device enclosed with the shipment and its position during transport can be queried by the control unit.

By using tracking devices by individual users, the stock level of tracking devices at the respective users decreases, who has enclosed a tracking device with a shipment. If a shipment with a tracking device reaches the recipient, the control unit can transmit a destination instruction to the tracking device, for example, which causes the destination address information to be displayed on the graphic output unit for forwarding the tracking device to another user, e.g. the second user. Upon receiving the destination instruction, the tracking device causes destination address information to be output on the graphic output unit. The destination address information indicates, for example, to which user the tracking device is to be forwarded. For example, the control unit can transmit destination address information for one of the users who has an increased demand for tracking devices or whose stock level has decreased significantly or is likely to decrease. Alternatively, it is possible that the tracking device stores multiple destination address information and the destination instruction transmitted by the control unit selects one of the stored destination address information, which is then displayed on the graphic output unit.

For the purposes of the present description, a destination instruction is to be understood as an instruction and/or data information that is sent from the control unit to the tracking device in order to cause destination address information to be output on the tracking device's graphic output unit. Destination address information can be an instruction that is readable by the recipient and/or can represent a postal address. The destination address information may also optionally include a machine-readable optical code, for example a QR code or a barcode. For the tracking device to be forwarded to another user, e.g. the second user, the control unit can initially send a first destination instruction and then a second destination instruction at a later point in time. After receiving the first destination instruction, a first destination address information can be issued, for example, which is addressed to the recipient and asks him, for example, to take the tracking device to the post office, to put it in a letterbox, or to take it to a reverse vending machine (return device). The second destination instruction can then, after the return has been made, trigger the issue of a second destination address information, which is addressed to the logistics company or companies, for example a postal company, which then takes over the actual forwarding of the tracking device to the second user. The second destination instruction can be transmitted at a later time than the first destination instruction. It is also possible that no first destination instruction is transmitted, since the first destination address information is printed or stored on the tracking device as a general instruction. In this case, the second destination instruction represents the destination instruction transmitted by the control unit.

In principle, it is possible to adapt the destination address information dynamically, in particular depending on (as a function of) the need for tracking devices among individual users. This makes it is also possible to react relatively quickly to a changing demand for tracking devices during the re-dispatch of the tracking devices from the recipient to, for example, the second user, and to send the tracking device to a third user, for example, for whom an even greater demand has arisen at short notice.

This means that the tracking device taken by the recipient from the shipment is not necessarily returned to the user who sent the shipment to the recipient, but to the user who currently has a high demand for tracking devices. Furthermore, this avoids the need for tracking devices to be sent back to a central distribution centre first, and then on to the individual users. This saves transport costs, energy and time, and increases the overall availability of tracking devices. As a result, fewer tracking devices are needed overall, which in turn saves resources.

The operator of the tracking system, which operator provides the individual tracking devices, makes the tracking devices available to users on request, and operates or monitors the control unit, is to be distinguished from the users. For example, a user can order a certain number of tracking devices from the operator, which are then delivered to that user by the operator. At the same time, the user can, for example, define a minimum stock quantity of tracking devices. The minimum stock quantity represents a parameter for the operator to control the forwarding of the individual tracking devices after they have arrived at the respective recipients. Users can adjust the minimum stock quantities. The minimum stock level (minimum stock quantity) can be stored in the control unit. Since the operator has an overview of the local distribution of the tracking devices and their current status (tracking device is currently being used for tracking, tracking device is inactive at a user, tracking device is being forwarded to another user) via the control unit, the operator can control both the targeted forwarding of a tracking device from a recipient to a user and the provision of additional tracking devices to a user and to react in good time to possible bottlenecks at individual users. In addition, it is possible for the operator to transmit destination instructions with destination address information to individual tracking devices for sending to a central warehouse so that the tracking devices can be checked and/or maintained and/or recharged if necessary in the central warehouse, or so that a software update can be carried out, for example.

The tracking devices are often also referred to as trackers because they can be used to track the progress of a shipment. A tracking device therefore includes at least the communication module, which enables wireless connection and/or wireless communication with the control unit, in particular via a communication network. The wireless communication can take place repeatedly, for example periodically, when certain events occur, or through a targeted contact by the control unit and/or the tracking device. For example, activation is a specific event, following which the tracking device establishes a connection with the control unit to notify the control unit of the activation. The control unit can, for example, communicate with the tracking device after the tracking device has transmitted a status message to the control unit. For example, after the status message has been transmitted, the communication module can transition to a send and receive mode for a predetermined period of time to enable communication with the control unit. After the predetermined period of time has elapsed, the communication module can be deactivated until another status message is transmitted. This can reduce the energy consumption of the tracking device.

Furthermore, the tracking device has at least the graphic output unit. The graphic output unit is configured so that destination address information can be displayed using the graphic output unit. The destination address information is preferably a postal address. The destination address information can be provided in plain text and/or as a machine-readable code. The graphic output unit can be controlled so that different destination address information can be displayed by the graphic output unit as required.

The graphic output unit can be a passive display, i.e. one that does not illuminate itself. Examples include electronic paper, for example based on electrophoresis (black and white particles with different charges). However, an active display, i.e. one that illuminates itself, can also be used. Examples include OLED displays.

To use a tracking device, the tracking device is first be activated at the user's premises or by the user who wishes to send a shipment. Activation is understood here to mean the process of bringing the tracking device from an idle state to an operating state. In addition to the idle state and the operating state, there may also be an off state and a transmission state. In the off state, the power supply to the tracking device is interrupted or deactivated, so that the tracking device does not perform any functions. The tracking device can only be transferred from the off state to the idle state or the operating state by an active action, for example by the user. Activation can also occur automatically for the user, for example if the user uses a dispatch system with automated provision of tracking devices from a magazine or similar apparatus.

In the idle state, the power supply is present or activated so that the tracking device can perform at least basic functions. For example, communication with the control unit, i.e. communication between the control unit and the non-activated tracking device, may not be possible by the tracking device, i.e. the communication module is inactive. Alternatively, in the idle state, limited communication, for example only at longer time intervals, is possible between the control unit and the tracking device. For example, in the idle state, the tracking device can transmit status information to the control unit at longer time intervals in order to signal to the control unit that the tracking device is basically ready for use. In the idle state, the graphic output unit can also be deactivated. If, for example, an electronic paper is used for the graphic output unit, the last displayed information can remain visible even after deactivation, since electronic paper only requires energy to change the display.

In the operating state, i.e. when the tracking device has been activated, all the functions of the tracking device are available. By contrast, the transmission state describes a state of a tracking device from which the tracking device in the operating state has been assigned to a shipment and this assignment is stored in the control unit. For this purpose, the shipment can have a unique shipment identifier and the tracking device can have a unique identifier. The unique identifier can be present on the tracking device as a machine-readable code.

During activation, the shipment identifier and the unique identifier of the tracking device can be transmitted to the control unit and assigned to each other. It is also possible for the assignment of the shipment identifier and the unique identifier to take place before or after activation. For example, when a carrier is commissioned electronically to ship the consignment (shipment), for example a courier service, the unique identifier of the tracking device can be transmitted to the carrier. The assignment of the unique identifier and the shipment identifier provided by the carrier can then be made at the carrier's premises, who then also transmits this assignment to the control unit, or the control unit requests this assignment from the carrier. Alternatively, the user can request the shipment identifier from the carrier and transmit it to the control unit together with the unique identifier, or the control unit can request it. Activation can also take place at a later time. The assignment of the shipment identifier and the unique identifier can therefore also take place without prior activation of the tracking device. However, activation should preferably take place before assignment. By transmitting the assignment and registering it in the control unit, it is possible to track the shipment by querying the position of the tracking devices.

When the shipment reaches the recipient together with the tracking device, this is transmitted to the control unit and the assignment between the shipment and the tracking device is cancelled. The tracking device then changes from the transmission state to the operating state. In the transmission state, all the functions of the tracking device, as in the operating state, are fully available. The transmission state can therefore also be regarded as a special form of the operating state, in which, for example, certain functions are called up more frequently. The difference between the operating state and the transmission state is then essentially the assignment of the tracking device to a shipment. In the transmission state, the graphic output unit can be deactivated when used in a shipment, since this is not absolutely necessary. In particular, when using displays based on electronic paper for the graphic output unit, it is possible that the last information displayed remains visible even after the graphic output unit has been deactivated.

Furthermore, it is possible that certain functions of the tracking device are activated or executed differently, for example more frequently, depending on the respective state in which the tracking device is located. For example, in the transmission state, determining the position has a higher priority than, for example, in the operating state before the actual transmission of the shipment. Therefore, the position of the tracking device can be determined more frequently in the transmission state than in the operating state.

To activate a tracking device, the user can supply contactless energy to the tracking device, for example. To do this, the user can place the tracking device on an induction device, comparable to an induction device for the contactless charging of mobile phones, for example. The tracking device can have a contactless charging interface for this purpose, for example. As soon as the tracking device is activated, i.e. has been transferred to the operating state, this is indicated to the user. This can be done, for example, by means of the graphic output unit or another optical display device, for example an LED. The brief supply of energy can, for example, start an activation routine that is stored in a memory of the tracking device. In principle, the power supply can be used not only for the actual activation, but also for charging a rechargeable energy source that is integrated into the tracking device.

Alternatively or additionally, it is possible for the tracking device to have a data communication module, for example an RFID transponder (near-field communication module), that serves as an input and output device. To activate the tracking device, it can be brought close to an RFID reader, for example, which can read the identifier of the tracking device and transmit an activation signal to the RFID transponder. The RFID transponder can be designed for NFC (Near Field Communication). In this case, it is possible, for example, to activate the tracking device and exchange data using an NFC-compatible mobile terminal. This means that the user does not need any additional hardware, for example, so that the use of the tracking devices does not lead to additional costs. In addition, a data connection can then be established via the mobile terminal to the control unit and the activation of the tracking device can be transmitted to the control unit and/or verified. The activation of the tracking device can also be transmitted directly from the tracking device to the control unit via the communication network.

In accordance with one embodiment, the user of the tracking device can supply energy to activate the tracking device, in particular, supply contactless energy, in order to thereby transfer the tracking device from an idle state to an operating state.

According to a further embodiment, which can be implemented with any further embodiment described here, alone or in any combination, the tracking device further comprises, as a data communication module, a short-range communication module, for example a Bluetooth module, for communication over short to medium distances.

For the sake of clarity, the communication module for communication with the control unit will be referred to as the first communication module or long-range communication module, the near-field communication module as the second communication module, and the short-range communication module as the third communication module. Both the near-field communication module and the short-range communication module generally represent a data communication module that is used to exchange data with an operator device or transmitter/receiver and/or to localise the tracking device indoors. The second communication module (near-field communication module) allows communication up to a distance of a few centimetres to a few metres, typically no more than 2 metres. The second communication module is therefore preferably designed for near-field communication (NFC) or RFID communication, in particular for bidirectional near-field communication. The third communication module (short-range communication module) allows communication up to a distance of several metres to several tens of metres. Typically, sufficiently stable communication can be achieved up to about 30 metres. Examples of the third communication module (short-range communication module) include, in particular, EnOcean, DECT ULE, Bluetooth (LE Bluetooth), ZigBee and Z-Wave. The first communication module (long-range communication module) allows communication over greater distances, in some cases of up to several tens of kilometres. The first communication module thus enables communication over a greater distance than the data communication module (third communication module and/or second communication module), which is intended for local data exchange. The third communication module enables communication over a greater distance than the second communication module.

In the context of this description, a module is understood to be a device or apparatus that provides a specific function. A module can be implemented as a stand-alone unit or in combination with another module or another apparatus.

The third communication module (short-range communication module) can also be used to determine the position of the tracking device indoors, which is preferable, since indoors, determining the position via the communication network is often too inaccurate or not possible at all. An additional localisation module, such as a GPS module, could also be used. However, such a localisation module only allows a global position to be determined, whereby the position determination using a localisation module is often too inaccurate inside buildings or is not possible at all due to weak signal reception. Within buildings, for example when using the tracking devices in dispatch systems or distribution systems, it is often not a global position that is of interest, but only a relative position. One example is a dispatch system in which an automatic assignment of shipment identifier and unique identifier takes place. Another example is a central distribution system, such as a logistics hub. For shipping and distribution systems, it is of interest where the individual shipment or tracking device is located within the system, since certain actions may be associated with the current position. For relative positioning, these systems have, for example, fixed receiver units or receiver-transmitter-units that can only receive, only send, or send and receive. If, for example, a shipment with a tracking device is routed to a station within the system (shipping system or distribution system), the tracking device can communicate with the (electronic) receiver-transmitter-unit(s) and transmit the unique identifier, for example. This means that the system knows the position of the tracking device within the system, since the tracking device is in the vicinity of this (electronic) receiver-transmitter-unit. The relative position determined in this way (proximity to a specific receiver-transmitter-unit) can be used for various purposes.

The following is an example of an automatic assignment of shipment identifier and unique identifier. For example, a tracking device may already be enclosed with a shipment. The tracking device may already be in the operating state, i.e. it is activated. In the user's dispatch system, the shipment can be automatically fed to a parcel labelling station, for example. The parcel labelling station is set up to provide the parcel, i.e. generally the shipment, with a parcel label (address label). The parcel labelling station or the environment of this parcel labelling station can, for example, be equipped with one or more Bluetooth receiver-transmitter-units that communicate with the short-range communication module, in the present example a Bluetooth module, when the shipment with the tracking device comes into the vicinity of the Bluetooth receiver-transmitter-unit. To do this, the tracking device can, for example, regularly send Bluetooth signals, which are received by the Bluetooth receiver-transmitter-units, which may be spatially distributed, and can be used to determine the position of the tracking device. The Bluetooth receiver-transmitter units, for their part, can transmit the determined position to the tracking device and/or exchange certain instructions or data with the tracking device. An automatic assignment between the unique identifier of the tracking device and the printed shipment identifier can then already take place here. However, this assignment often only takes place at a further station. For this purpose, the parcel marked with the shipment identifier and destination address is automatically fed to a further station, which or whose environment is also equipped with one or more Bluetooth receiver-transmitter units. At this further station, the printed shipment identifier is optically read. At the same time, it is possible to check whether the imprint or the affixed label is legible. The Bluetooth receiver-transmitter-units enable the system to identify which shipment (by optical recognition) and which tracking device (by reading the unique identifier via Bluetooth) are currently at this station. This enables the assignment to be made and transmitted to the control unit.

In a distribution centre, the shipment can be tracked either by optical recognition of the shipment identifier and/or by reading the unique identifier of the tracking device that is included with the shipment. This also allows the handling of shipments to be adapted.

According to a further embodiment, which can be implemented alone or in any combination with each further embodiment described here, one of the following steps, in particular by the first user, can be carried out to activate the tracking device: operating a switching element of the tracking device, for example a piezoelectric element, a membrane switch or a pushbutton; feeding the tracking device to a charging device, for example by placing it on a charging device for contactless charging; removing the tracking device from a charging device; removing or dispensing the tracking device from a magazine for storing a plurality of tracking devices.

This makes it possible to supply energy to the tracking device. In this context, ‘supply of energy’ also refers to the activation of the power supply in the tracking device, e.g. by operating a switching element.

To ensure full functionality, it is advantageous, according to one embodiment, for the user to have a charging device or a magazine for storing tracking devices, in which the tracking devices are not only stored but also charged and their charge state monitored. In the simplest case, commercially available charging devices can be used for contactless charging of mobile devices. This solution is suitable, for example, for users with a low demand for tracking devices. For users with a high daily demand, suitable magazines are advantageous because when a tracking device is removed from the magazine, the tracking device is already charged. In addition, the removal process can simultaneously lead to an automatic activation of the tracking device, without the user having to take any further action.

The magazines preferably have their own communication interface (data connection) to the control unit and can thus automatically transmit the activation to the control unit. The communication interface can be an interface for establishing a mobile phone connection, an interface for establishing a landline connection, an interface for establishing a LAN connection or an interface for establishing a WLAN connection, which are typically used for data communication with high throughput.

The magazines also make it possible for the control unit to easily monitor the stock level of tracking devices at the user who uses the magazine. For this purpose, the magazine can be set up to transmit status information to the control unit each time a tracking device is removed from or added to the magazine.

According to a further embodiment, which can be implemented with each further embodiment described here, either alone or in any combination, the communication module (first communication module or long-range communication module) is in wireless connection with the control unit via a communication network. The control unit can repeatedly query the position of the activated tracking device at the communication network, which determines the position of the activated tracking device. Preferably, the communication network is a low power WAN (low power wide-area network). Low power WAN is used here to describe a group of different power-saving WAN technologies that can exist in many types and forms. Low power WANs can utilise licensed or unlicensed frequencies and can use both proprietary and open standards. The communication module (first communication module or long-range communication module) is a communication module that is set up to communicate with a low power WAN communication network.

Examples of low power WAN are DASH7, LoRaWAN, Sigfox, mioty, LTE-M, NB-IoT, Weightless-N, Weightless-P, Weightless-W, GreenOFDM, Symphony Link, ThingPark Wireless. LoRaWAN, LTE-M, NB-IoT and Sigfox are preferred. For example, the communication network can enable communication in the so-called Short Range Device frequency band (SRD frequency band), for example in the range of 863 to 870 MHz frequency band, preferably 868 MHz (primarily in Europe), or also in the range of 902 to 928 MHz (primarily in North and South America). Communication networks based on low-power WAN are typically characterised by a low bandwidth and low bit rate compared to mobile networks, but this allows the communication module to be operated with a very low power consumption, which means that the tracking device lasts significantly longer than mobile terminals that communicate via mobile networks.

The current position or location of the activated tracking device can be determined by using the functionalities of the communication network. To query the current location, the control unit sends a corresponding request to the communication network. Since the communication network has distributed base stations, the communication network knows which base station is currently communicating with the tracking device. The communication network thus knows the current location of the tracking device and can transmit it to the control unit. The location determined by the communication network can also be referred to as an approximate location, since the accuracy of the location determination can be affected by local conditions (spatial distance of the base stations, reception quality). However, this approximate location is sufficient for determining the position in the context of tracking in most cases.

Even if the communication network can only transmit an approximate location in certain situations, this information is sufficient in most cases. To determine a more precise position, the tracking device would have to have its own localisation module or activate one. However, this would result in higher energy consumption by the tracking device, which would have a negative impact on the tracking device's operating time. Therefore, determining the location by the communication network is used first.

Both the user who sent the shipment and the recipient of the shipment can use the control unit to query the current location of the tracking device and thus of the shipment.

In order to reduce the energy consumption of the tracking device, the activated tracking device, i.e. the tracking device in the transmission state, can send a signal, e.g. a status message, to the communication network so that the communication network can determine the position of the activated tracking device. This can be done, for example, when the tracking device is moved or when a state of motion of the tracking device changes. Based on this change in state registered by the tracking device, the tracking device, i.e. the communication module, can be brought to a transmission mode for a certain time so that the tracking device transmits at least one signal, e.g. a status message in the form of a data packet. This enables the communication network that receives the signal to determine the location of the tracking device. Since, according to embodiments, the signal can be transmitted without confirmation of receipt by the communication network and the tracking device is therefore not notified of receipt, it may be provided that the tracking device transmits a signal multiple times. For this purpose, the tracking device can remain in transmission mode for a certain period of time. This is advantageous in the case of locally unfavourable reception and transmission situations.

The time limitation of the transmission mode is particularly advantageous for reducing energy consumption. Since the tracking device preferably only communicates with the communication network at relatively long time intervals, but is preferably in neither the transmission mode nor a reception mode during the rest of the time, energy consumption is very low. For example, when the tracking device is in the transmission state, i.e. when it is transported together with an assigned shipment, it can be set to transmission mode once an hour for a short time, e.g. for one minute, and communicate with the communication network so that the communication network can determine the current location of the tracking device.

The transmission mode, in contrast to the transmission state of the tracking device, only describes the state of readiness for transmission of the tracking device's communication module. The tracking device can therefore, when it is in the transmission state, i.e. when it is transported together with a shipment, be temporarily set to a transmission mode and/or a reception mode. The tracking device can also be temporarily set to the transmission mode and/or the reception mode in the operating state and/or idle state. The transmission mode is typically used for the tracking device to send data packets to the communication network and/or the control unit so that the current position of the tracking device can then be determined via the communication network. Of course, other specific information can also be transmitted to the control unit.

According to a further embodiment, which can be implemented with each further embodiment described here, alone or in any combination, the activated tracking device sends a signal to the communication network so that the communication network can determine the position of the activated tracking device when the tracking device is moved or when a state of motion of the activated tracking device changes. This then results in a state-based location determination if the activated tracking device is moved. If, for example, the transport vehicle is parked in a car park overnight, there is no need for a regular location determination, since the last location determination is still stored in the control unit and can be retrieved there.

However, it is also possible to combine the regular location determination by short-term communication of the tracking device at periodic intervals with the state-related location determination, which is activated by a motion of the tracking device, i.e. due to a registered change of the state. It is thus possible for the regular location determination to be activated after a certain period of time if the tracking device is not moved for a longer period of time. The regular location determination can also be deactivated again by moving the tracking device.

According to a further embodiment, which can be implemented with any further embodiment described herein alone or in any combination, the tracking devices further each comprise a localisation module to determine the position of the tracking devices, wherein the determination of the position by the localisation module is independent of the determination of the position by the communication network. In particular, the localisation module may have a GPS module and/or a Glonass module and/or a Beidou module and/or a Galileo module.

If a more precise position determination is required, the tracking devices can each have their own localisation module. The respective tracking device can then either determine its current position itself repeatedly, e.g. periodically, and transmit it to the control unit or store it in an internal memory for later purposes, or determine its current position at the request of the control unit and transmit it to the control unit.

According to a further embodiment, which can be implemented alone or in any combination with any other embodiment described herein, the localisation module is activated when the activated tracking device reaches a predetermined area. The activated tracking device can then transmit its position determined by the activated localisation module to the control unit.

The predetermined area can, for example, be the target area of the recipient. For this purpose, it is sufficient if the position is initially monitored by the communication network and regularly transmitted to the control unit and/or transmitted by the control unit on request. The control unit may also transmit the position to the tracking device. When the shipment reaches the target area of the recipient with the tracking device, an instruction to activate the localisation module can be sent to the tracking device by the control unit, for example. Alternatively, the tracking device activates the localisation module independently when it reaches the target area. For example, it is possible that the tracking device is informed of the current position by the communication network, possibly after a request from the control unit, and the tracking device then activates the localisation module when the tracking device reaches the target area. Alternatively, the tracking device can determine its position independently, for example by triangulation using base stations of the communication network. The target area or its size can be determined beforehand, for example automatically by the control unit depending on the position of the recipient, i.e. the location to which the shipment is to be sent.

According to a further embodiment, which can be implemented with any further embodiment described herein alone or in any combination, the tracking devices further each comprise a rechargeable energy source. The energy source may, for example, be at least partially charged upon activation. The energy source can be designed with a comparatively low capacity, as the energy consumption of the tracking devices is low. This is due, for example, to the fact that the tracking devices rarely establish communication with the control unit. As explained above, the tracking devices are localised, i.e. their position is determined, by means of the communication network, which remains in contact with the tracking devices by sporadically establishing a connection. The localisation module does not need to be activated. It can only be activated when the target area is reached. Rechargeable lithium-ion button cells, for example, can be used as an energy source.

In addition, the tracking devices communicate in particular only via low power WAN communication networks, so that the energy consumption is significantly lower compared to mobile radio networks. The tracking devices therefore preferably do not have a mobile radio module (e.g. GSM, UMTS, LTE, GPRS, 5G), which has a comparatively high energy requirement.

According to a further embodiment, which can be implemented alone or in any combination with any other embodiment described herein, the tracking devices further each comprise a machine-readable code, each comprising a unique identifier. The machine-readable code and thus the unique identifier is read by the user when the respective tracking device is activated. Optionally, the unique identifier can also be visible as human-readable writing (e.g. letters, numbers and special characters) on the respective tracking device.

The identifier read out can be transmitted to the control unit. Furthermore, the activated tracking device can be assigned to a specific shipment so that the shipment can be tracked via the tracking device. In addition, the destination address of the recipient and/or the name and/or a customer number of the recipient can also be assigned to the pair formed in this way from the shipment and the tracking device assigned to this shipment. The destination address can then be used to determine the target area.

According to a further embodiment, which can be implemented with any other embodiment described herein alone or in any combination, the tracking devices are provided to the users by an operator.

The operator provides the tracking service (tracking system), i.e. it operates or monitors the control unit, which communicates with the tracking devices via the communication network. The current location of the tracking devices and thus of the respective shipment can be queried via the control unit. For this purpose, the operator can provide the users, and possibly the recipients, with an interface or web access or app access.

The operator equips the users with the tracking devices. The respective user reports their need for tracking devices to the operator. The operator then supplies the tracking devices to the user. Depending on the user's specifications, the operator delivers further tracking devices as required or ensures that tracking devices that have just arrived at a recipient are sent directly to the individual users. The corresponding destination instructions are then sent to the individual tracking devices.

According to a further embodiment, which can be implemented alone or in any combination with any other embodiment described herein, the destination instructions, after receipt of the shipment with the tracking device by the recipient, are additionally determined as a function of the current location of the tracking device. This enables the respective tracking device to be sent to the user closest to the current position of the tracking device, where there is a high demand for tracking devices. This avoids long transport routes. Even if, for example, a distant user has an even higher demand for tracking devices, it may make sense to avoid shipping the tracking devices over long distances in order to optimise the distribution of the tracking devices, as this increases the transport distances and transport time and thus reduces availability. In addition, the ecological footprint of each shipment is reduced.

According to a further embodiment, which may be implemented with any other embodiment described herein alone or in any combination, the control unit transmits the destination instructions to the tracking device only after receiving a confirmation that a predetermined event or the sequence of at least two predetermined events has occurred. For example, dropping the tracking device into a mailbox or returning the tracking device to a reverse vending machine may comprise or constitute the predetermined event or events.

This can ensure that the destination instruction is only transmitted once the tracking device has been returned to the redistribution cycle by the recipient. For example, a recipient, such as a private individual, may only post the tracking device in a letterbox after a few days. If the destination instruction were already transmitted when the recipient receives the shipment, then the destination instruction could already be out of date when it is placed in the letterbox a few days later. It is therefore beneficial from the point of view of improving the provision of tracking devices if the destination instructions are only transmitted at a comparatively late point in time, for example when the tracking device has been forwarded by the recipient. It is possible that a general destination instruction (first destination instruction) is first transmitted to the tracking device, which requests the recipient to deposit the tracking device in a letterbox or a return machine, for example, by issuing general destination address information. Furthermore, the tracking device can also autonomously issue general instructions, such as a request to return the shipment to the operator because the battery needs to be replaced or is almost empty or a software update needs to be performed, or simply a request to acknowledge receipt of the shipment. These general instructions can be stored in the tracking device, for example in the memory. A specific destination instruction (second destination instruction) is only transmitted to the tracking device after the item has been deposited in the letterbox or return machine and causes destination address information to be output on the graphic output unit, for example the address of the second user. This has several advantages.

Firstly, the recipient is not immediately informed of the address of the second user. This makes sense for data protection reasons. On the other hand, the address of the second user is only transmitted at a time when the tracking device has already been forwarded by the recipient. This allows the control unit to transmit a currently adapted destination instruction to the tracking device, which takes into account the current requirements of the user. For example, it is possible that a recipient of the tracking device does not drop it in a letterbox immediately, but only after a few days. If, at the time the tracking device was received by the recipient, the demand for further tracking devices from another user was very high, this demand requirement can change within a few days. If the control unit were to determine the destination instructions as soon as the tracking device is received, the tracking device would still be sent by the recipient to the other user days later, even if the latter no longer has a high demand. By transmitting the destination instruction only after the tracking device has been forwarded by the recipient, the current demand can be taken into account.

As explained above, only the second destination instruction can be transmitted.

Instead of a letterbox, the tracking device can also be placed in a special reverse vending machine by the recipient. This allows the recipient to be credited with a bonus, for example. This also incentivises the recipient to return the tracking device. A bonus can also be credited to the recipient when the item is returned via a letterbox. For example, the bonus can be credited when the tracking device is received by the user (e.g. the second user) to whom the tracking device was forwarded by the recipient.

According to a further embodiment, which can be implemented alone or in any combination with any other embodiment described herein, confirmation is provided by the tracking device that the event detected by the tracking device has occurred. For this purpose, the tracking device can have sensors that detect the event. For example, this may be a light sensor and an acceleration sensor. When a letter is placed in a letterbox, the brightness conditions suddenly change, which can be recognised by the light sensor. When the tracking device hits the bottom of the letterbox, the tracking device is stopped abruptly. The acceleration sensor is used for this purpose. If both sensors recognise an event (change in light, abrupt stop) within a narrow time interval, then a recognised event is assumed.

According to one embodiment, which can be implemented alone or in any combination with any other embodiment described herein, a method for distributing tracking devices is proposed, in which a plurality of tracking devices are each available to a plurality of users, wherein the tracking devices each have a communication module and a graphic output unit and can communicate or are in connection with a control unit independently of one another wirelessly via the communication module. The tracking devices can be designed as described above and communicate with the control unit via a communication network. The control unit monitors the stock level of the tracking devices at some or all of the users, as well as the demand for tracking devices by the users. For example, the control unit can query the position of the individual tracking devices and thus recognise whether a tracking device is currently being used to track a shipment or is still with one of the users. After a tracking device has been used by a user to track a shipment to a recipient, the control unit transmits destination instructions to this tracking device after this tracking device has arrived at the recipient together with the shipment, which causes destination address information to be displayed on the graphic output unit for onward transmission to one of the users. The destination instructions are determined by the control unit depending on the demand for tracking devices by the users and/or depending on the stock level of tracking devices at the users.

The method for distributing tracking devices can be used regardless of whether and how the tracking devices are activated. It is only essential that the control unit recognises that the tracking device has arrived at the recipient. This recognition can be done by interrogating the position and/or by acknowledging receipt by the recipient, as described above. The control unit then determines to which user the tracking device is to be forwarded by the recipient. For this purpose, the stock level of the individual users, the geographical distribution of the individual users and the current and expected demand for tracking devices based on empirical values are taken into account. The stock level is either known to the control unit or can be determined or checked by querying the position of the tracking devices. The geographical distribution is also known to the control unit. The current demand can fluctuate and can be specified by the users as a fixed minimum stock level or dynamically adapted by the users. The current demand and the current stock level can be understood as parameters which are used by the control unit to determine the destination address information, taking into account the geographical distribution of the users, i.e. in particular the distance between the recipient and the individual users. The control unit can therefore continuously evaluate to which user a tracking device that has just arrived at a recipient should be forwarded. This enables efficient, cost-effective and resource-saving redistribution of the tracking devices.

According to a further embodiment, which can be implemented alone or in any combination with any other embodiment described herein, a method for tracking transport containers is disclosed, in which a plurality of transport containers are provided, each with a tracking device attached to the respective transport container, in particular detachably, for use at different locations, wherein the tracking devices each have a communication module and the tracking devices can communicate wirelessly with a control unit independently of one another via the communication module, wherein the transport containers are set up to hold one or more transport goods. At least some of the transport containers are used to send transport goods between the locations, wherein at least one transport container holds at least one transport good, which is sent from one location to another location by means of the transport container. During the transport of the transport containers between the locations, the position of the tracking devices attached to the transport containers and thus of the transport containers is repeatedly transmitted to the control unit. The position of the tracking devices attached to the transport containers, and thus the position of the transport containers during transport of the transport goods, can be tracked via the control unit. The control unit monitors the stock level of the tracking devices and thus of the transport containers at some or all locations. Depending on the demand for transport containers at the individual locations and/or depending on the stock level of transport containers at the individual locations, the control unit generates instructions for shipping empty transport containers without transport goods between the locations. The empty transport containers will be sent between the locations based on the generated instructions.

In this method, a single tracking device is firmly, preferably detachably, connected to a transport container. Preferably, the tracking device is attached to the outside of the transport container so that the tracking device can be easily replaced.

The transport container is preferably a dimensionally stable container, for example made of plastic or metal, which can be reused several times, in contrast to cardboard and paper packaging, whose shelf life is often only sufficient for a few uses. The transport containers are not limited to certain goods. For example, a transport container can also be a container trolley or special pallets for transporting goods, including larger goods (e.g. motorbikes). A beverage crate can also be a transport container.

The transport container can have a closable opening through which the transport goods can be placed in and removed from the interior of the transport container. For example, the transport container can have a lid. However, it is also possible for the transport container to be open on one side and not have a lid.

In principle, the method can be carried out using the same principle as described above for shipments, so there is no need to repeat it here. However, it is not absolutely necessary to activate the tracking device every time. The tracking device can be permanently activated, as the tracking device can be equipped with a larger energy source, for example. Also, the form of the tracking device does not have to correspond to that described above, as a separate return of the tracking device is not necessary as described above.

A transport container is used to transfer transport goods from a first location to a second location, for example. At the second location, the transport goods are removed from the transport container. Similarly, another transport goods can be transferred from a third location to a fourth location using another transport container, for example, and removed from the other transport container there. In principle, at least some of the transport containers can be used to transport goods that have been placed in the transport containers for transport between the locations. After reaching the destination location, the respective transport goods are removed from the transport containers and the empty transport containers are then available for receiving and transporting further transport goods.

The first, second, third and fourth locations, or all locations, can be located within a company or the company has access to these locations. The method for tracking transport containers can therefore also be used within a company, or within a group of companies. Alternatively, the first location can also be a location that is assigned to a first user (e.g. a first company) and the second location can be a location that is assigned to a second user (e.g. a second company). The transport containers can be distributed across different locations at one user, i.e. within one company, or across different locations at different users, i.e. at different companies. The determination of demand and the forwarding of the transport containers after use can be carried out in the same way as in connection with the tracking devices when tracking a shipment.

In contrast to the tracking of shipments, which can be different shipments, the tracking of transport containers and redistribution of empty transport containers only takes place within a class of identical transport containers. For example, only transport containers with the same design, the same size and the same type of use are monitored. If a company uses two different classes of transport containers, for example, which differ in size and/or design, the distribution of empty transport containers is only determined within the same classes. The demand and/or the stock level at the individual locations is therefore only determined within one class of transport containers and used to generate the instructions for the demand-dependent or stock-level-dependent redistribution of empty transport containers in this class. Different classes of transport containers can be, for example, open transport crates with a uniform design and size, pallets with a uniform design and size, and lockable transport crates with a uniform design and size.

However, it is possible for the control unit to monitor the demand and/or stock level of transport containers of two or more different classes at the individual locations and to generate separate instructions for shipping the respective empty transport containers for each class of transport containers. The monitoring of the demand and/or stock level of transport containers and the generation of instructions for shipping the empty transport containers of this class are carried out independently of the transport containers of another class. However, the same tracking devices can be attached to the transport containers of the different classes, so that two or more classes of transport containers can be monitored with a uniform system, i.e. in particular with one control unit.

In contrast to the tracking of shipments, an assignment between the unique identifier of the tracking device and an identifier of the transport goods being transported with a transport container is not absolutely necessary, since the focus here is on the tracking and subsequent forwarding of the transport containers so that a transport container can be made available again as quickly and efficiently as possible after it has been used for the transport of transport goods from one location to another location, i.e. in particular it is forwarded to a location where there is currently a high demand for transport containers. However, it is possible for an assignment of the unique identifier of the tracking device to the container identifier of the transport container to be made and transmitted to the control unit.

When tracking and subsequently forwarding the transport containers, instructions for shipping empty transport containers are also generated depending on the demand for transport containers at the individual locations and/or depending on the stock level of transport containers at the individual locations. Optionally, the geographical distribution, i.e. the distance between the locations, can also be taken into account here.

The transport containers are preferably transport containers that are used for the local or internal movement of goods, for example transport boxes that can be moved by one person. Containers for long-distance transport, for example 20 foot or 40 foot containers, are not considered to be transport containers for the local or internal movement of goods. Preferably, the largest dimension (length, width or height) of a transport container does not exceed 2 metres.

According to a further embodiment, which may be implemented with any further embodiment described herein alone or in any combination, the method for tracking transport containers may comprise at least one of the following features, or a combination of these features:
(1) The tracking devices each have a graphic output unit, wherein the control unit transmits destination instructions to the tracking devices which cause the display of destination address information for shipping the empty transport containers with the respective tracking device to another location on the graphic output unit, wherein the control unit determines the destination instructions as a function of the demand for transport containers at the individual locations and/or as a function of the stock level of transport containers at the individual locations.
(2) The tracking devices each have a data communication module, for example a near-field communication module and/or a short-range communication module, in order to communicate contactlessly with an operator device, whereby the control unit transmits destination instructions to the tracking device, which can be read out contactlessly by means of an operator device via the data communication module and cause the output of destination address information for shipping the empty transport containers with the tracking device to other locations on the operator device, wherein the control unit determines the destination instructions as a function of the demand for transport containers at the individual locations and/or as a function of the stock level of transport containers at the individual locations.
(3) The tracking devices each have a data communication module, for example a near-field communication module and/or a short-range communication module, which can communicate with receiver-transmitter-units distributed at the individual locations for determining the position of the tracking devices, and thus for determining the position of the transport containers, wherein the positions of transport containers are determined by means of the receiver-transmitter-units and transmitted to the control unit, wherein the control unit checks on the basis of the determined positions whether empty transport containers have been provided for shipping and/or have already been shipped in accordance with the instructions prepared by the control unit.

According to a further embodiment, which can be implemented alone or in any combination with any other embodiment described herein, a method for tracking transport containers and for distributing transport containers is proposed, wherein a plurality of transport containers are each provided with a tracking device attached to the respective transport container for use at different locations. The tracking devices each have a communication module, a processor module and a graphic output unit and can communicate or be in connection with a control unit independently of one another wirelessly via the communication module. The transport containers are set up to hold one or more transport goods, whereby at least one transport good, which has been picked up in the transport container, is sent from a first location to a second location by means of a transport container with a tracking device attached to it. The position of the tracking device is repeatedly transmitted to the control unit during the transport of the transport container to the destination address. The position of the tracking device attached to the transport container can be tracked via the control unit. The control unit monitors the stock level of the tracking devices and thus of the transport containers at some or all locations. After the transport container has arrived at the second location together with this tracking device, the control unit transmits destination instructions to the tracking device, which cause destination address information for forwarding the transport container with the tracking device to another location to be displayed on the graphic output unit, the control unit determining the destination instructions as a function of the demand for transport containers at the individual locations and/or as a function of the stock level of transport containers at the individual locations.

The destination address information indicated on the graphic output unit can also be a machine-readable code, for example an internal code, if the transport containers are only used within a company.

The tracking devices used for tracking transport containers may differ from the tracking devices used for tracking shipments. In the case of tracking devices used for tracking shipments, a graphic output unit is important, as these tracking devices are distributed individually to another user, for example as a postal item. The respective destination address information for sending by post is therefore displayed on the graphic output unit.

In the tracking devices used for tracking transport containers, a graphic output unit is not absolutely necessary, but can advantageously be provided for displaying destination address information or other information.

Alternatively or additionally, the tracking devices used for tracking transport containers may have the data communication module described above to enable contactless communication with an operator device and/or local positioning. The data communication module can also be used to contactlessly transmit destination instructions from the tracking device to the operator device, which cause the output of destination address information for shipping the empty transport containers to other locations on the operator device, for example a graphic output unit of the operator device. A user can therefore bring an operator device into the vicinity of a tracking device attached to a transport container and thereby read it out.

The data communication module can furthermore also communicate with receiver-transmitter-units distributed at the individual locations for determining the position of the tracking devices, and thus for determining the position of the transport containers. The receiver-transmitter-units may preferably be Bluetooth receiver-transmitter-units, as described above. The data communication module therefore preferably comprises a Bluetooth module.

The receiver-transmitter-units can be used to determine the positions of transport containers, for example within a single location, and transmit them to the control unit. This allows the control unit to use the determined positions to check whether empty transport containers have been provided for shipping and/or have already been shipped in accordance with the instructions generated by the control unit.

A location can be, for example, a company site, a single building or a defined area. For example, there may be two or more locations within a company site, such as a goods receipt and a goods issue, a warehouse building, a goods distribution building and a production building. The locations can also be spread over several company premises that are far apart from each other or relate to individual ‘bases’. An illustrative example is a postal company that uses transport containers to deliver mail to local distribution centres or letter mail distribution boxes distributed throughout an urban area. The local distribution centres/depots and letterboxes can then represent separate locations.

The tracking devices used for tracking shipments may preferably additionally comprise the data communication module described above.

Preferably, the tracking device for all methods described herein comprises in particular the communication module (first communication module) for communication with the communication network, a rechargeable energy source and a processor module. The processor module can, for example, execute instructions (software) for operating the tracking device and thereby provide the required functions of the tracking device. In particular, tracking devices used for tracking shipments further comprise a graphic output unit.

Furthermore, the tracking device may preferably have an input and output device. This may comprise a data communication module, e.g. a near-field communication module (second communication module) and/or a short-range communication module (third communication module), or the data communication module may constitute an input and output device. When using the tracking device, the near-field communication module and/or the short-range communication module can be used for local input and output.

For example, users who only have a mobile terminal, such as a mobile phone, as an operator device for the tracking device and do not have a very high need for tracking devices will communicate with the tracking device using the near-field communication module, as this enables comparatively simple and direct communication without prior pairing. In addition, the detection of the relative position within buildings described above is of little interest to these users. Information read out from the tracking device via the operator device can then be displayed to the user on a graphic output unit of the operator device.

For users with a high demand for tracking devices, who have corresponding shipping systems, or for users for tracking transport containers, on the other hand, communication via the short-range communication module or additionally via the near-field communication module is of interest, as the slightly higher range of the short-range communication module means that the position of the tracking device can be detected quickly.

The short-range communication module, in particular in the form of a Bluetooth module, can be used, for example, to update the software stored in the tracking device. It is also possible to localise the tracking devices in buildings, distribution systems or shipping systems, or at the individual locations using the short-range communication module. A Bluetooth module also allows communication with all Bluetooth-enabled devices, such as portable computers, tablets and mobile phones.

Furthermore, the tracking device can preferably have at least two sensors selected from a light sensor, an acceleration sensor, a bending sensor and a rotation rate sensor. These sensors are used to detect the events described above. A bending sensor is optional for tracking devices for transport containers.

The tracking device, in particular for tracking shipments, preferably has a flat base body with a minimum dimension of preferably 7 cm×10 cm and in particular 9 cm×14 cm. The minimum size results from the requirements of postal companies for sending letters, as these should have a certain size. These requirements can vary in different countries and also between individual postal organisations. The length is preferably at least 1.4 times the width. Preferably, the flat base body has a thickness of no more than 1 cm and in particular no more than 0.5 cm. The individual components of the tracking device can also be integrated into such thin base bodies. Preferably, the tracking device has a maximum size of (length×width×thickness) of 235 mm×125 mm×5 mm.

The tracking devices used for tracking transport containers can also have other external dimensions, as these tracking devices are not forwarded separately and therefore do not necessarily have to have typical dimensions for postal items. These tracking devices may also contain, for example, energy sources with a higher capacity.

In the following, the invention will be explained by means of, but not limited to, examples of embodiments. It shows:

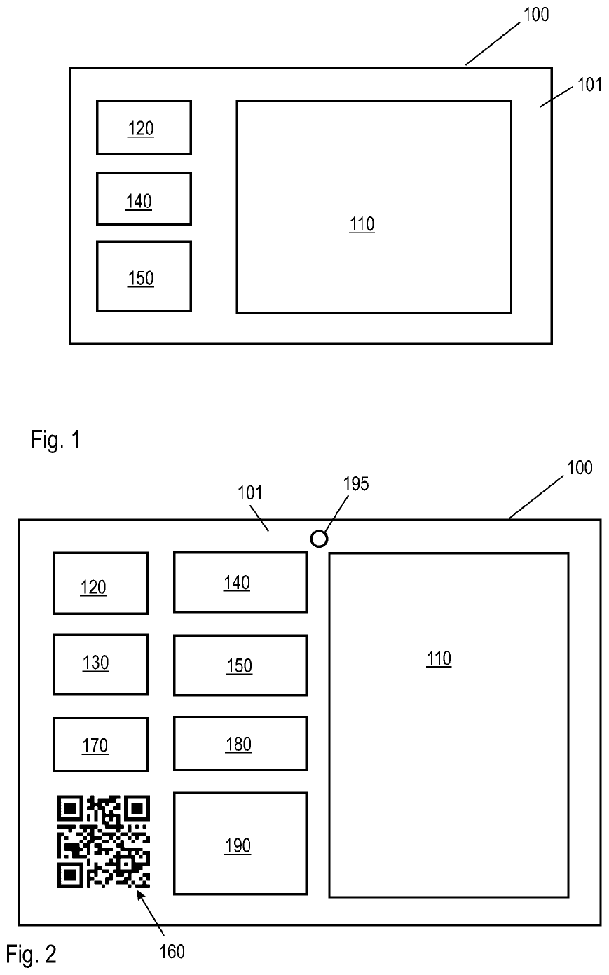

FIG. 1 shows a tracking device according to one embodiment.

FIG. 2 shows a tracking device according to another embodiment.

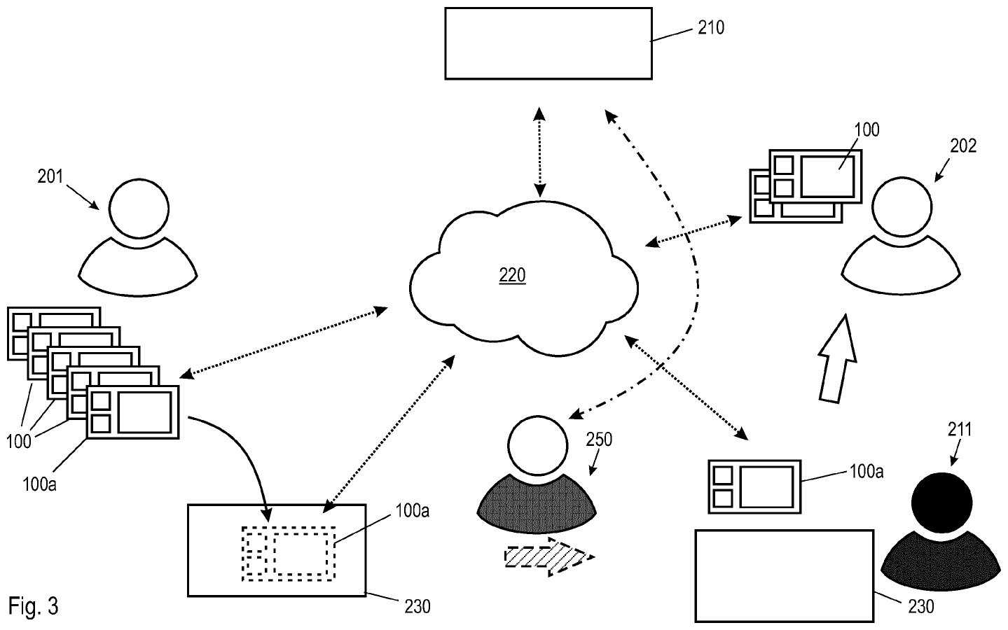

FIG. 3 schematically shows the sequence of a method for tracking shipments according to one embodiment.

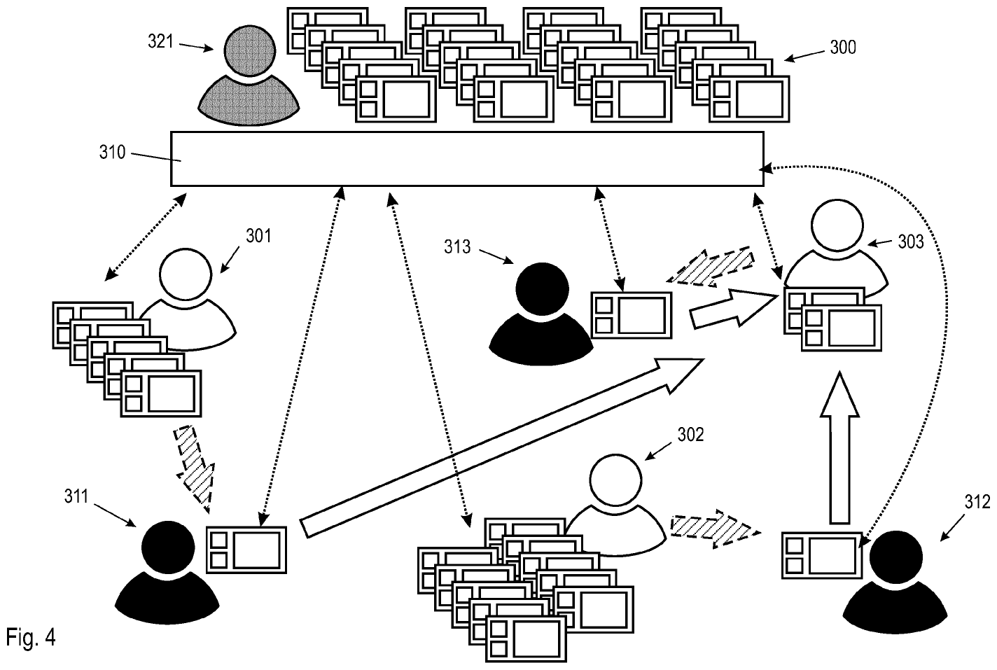

FIG. 4 schematically shows the sequence of a method for tracking shipments according to one embodiment, taking into account several users.

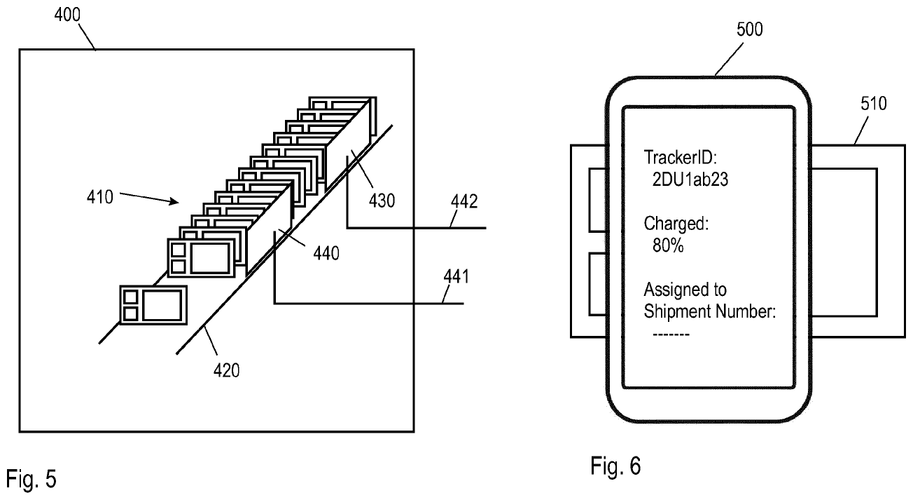

FIG. 5 schematically shows an apparatus for storing and dispensing a plurality of tracking devices.

FIG. 6 schematically shows the operation of a tracking device by means of a mobile phone communicating with the tracking device via the near-field communication module.

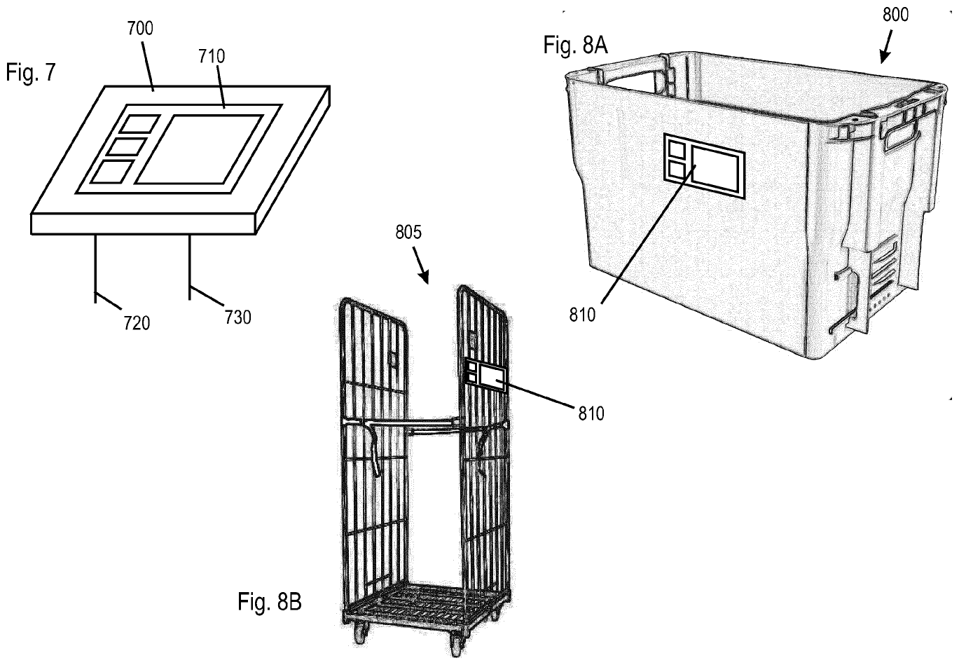

FIG. 7 schematically shows a charging device for a tracking device.

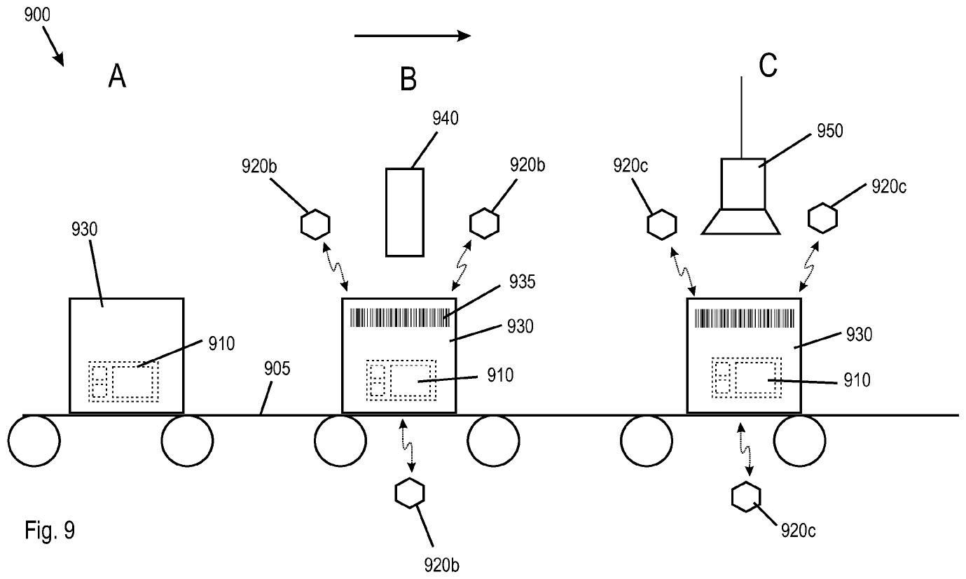

FIG. 8A schematically shows a transport container with a tracking device attached thereto, FIG. 8B shows a transport container in the form of a transport trolley with a tracking device attached thereto.

FIG. 9 schematically shows a dispatch system with a parcel labelling station and a station in which the assignment between unique identifier and shipment identifier is carried out using Bluetooth receiver-transmitter-units.

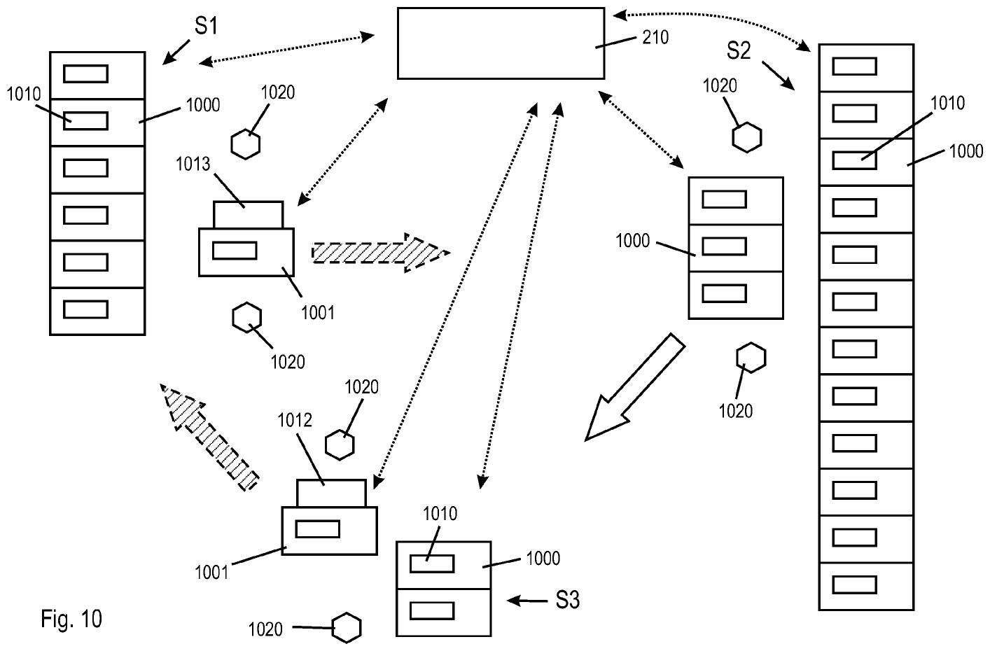

FIG. 10 schematically shows a method for tracking and redistributing transport containers between different locations.

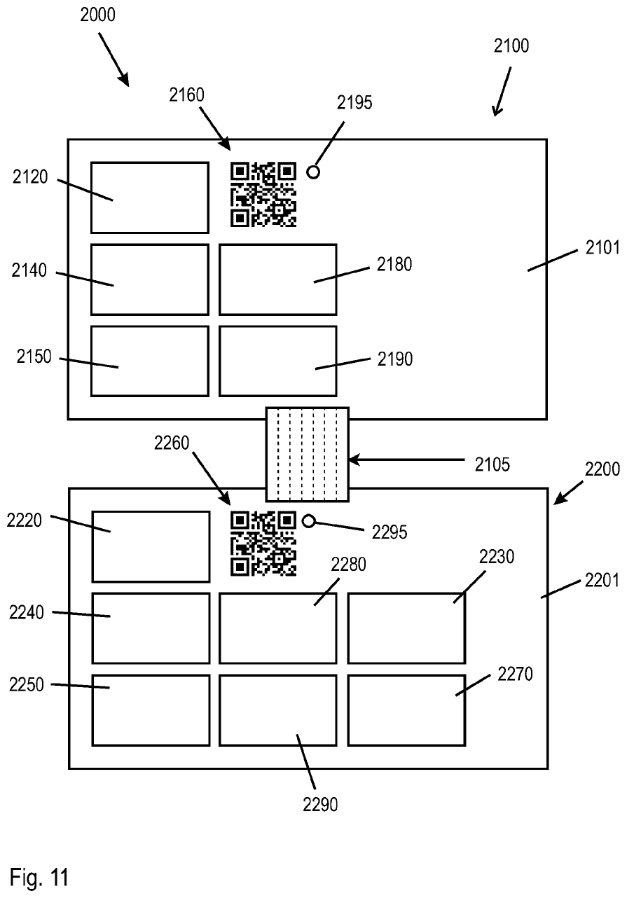

FIG. 11 shows a tracking device according to another embodiment.

For tracking shipments or transport containers, tracking devices are proposed that are particularly compact in design and light in weight. In particular, the tracking devices can be designed to be small in one dimension, which is referred to as thickness. Preferably, the tracking devices have a flat base body with a low thickness, which should not be more than 5 mm, for example. Preferably, the thickness is between 1 mm and 5 mm. A flexible but dimensionally stable material is used for the base body. In particular, the material from which the base body is formed is bendable, so that the base body as a whole is bendable.

For the purposes of simple forwarding of a tracking device from one recipient to another user, it is advantageous if the external shape and size do not exceed the dimensions of a C6/5 envelope (DIN 678-1: 1998-01). It is favourable if the tracking device does not exceed a size of (length×width×thickness) 235 mm×125 mm×5 mm. Furthermore, it is favourable if the weight of the tracking device does not exceed 50 g. A weight of no more than 20 g is preferable.

FIG. 1 shows a tracking device 100 according to one embodiment. The tracking device 100 has a base body 101 with the properties described above. The base body 101 has two opposite side surfaces, whereby in FIG. 1 only the side surface designated as the front side can be seen. Furthermore, the tracking device 100 has at least one graphic output unit 110, a communication module (long-range communication module) 120, a processor module 140, and an energy source 150.

The communication module 120 is set up and configured to establish a connection with a communication network not shown here and to communicate. Communicating here comprises both transmitting data from the tracking device 100 to the communication network and receiving data by the tracking device 100. The communication module 120 can be temporarily operated in different modes: transmission mode, reception mode, and transmission and reception mode. In transmission mode, the reception of data is inactivated. Data transmission is also deactivated in reception mode. Only in transmission and reception mode is both the transmission and reception of data activated.

By sending data using the communication module 120, the communication network can determine the position or location of the tracking device 100. For this purpose, it is sufficient if only short data packets are sent via the communication module 120 or if a connection to the communication network is established at all. In the simplest case, it is sufficient for the communication module 120 to be operated in transmission mode. In transmission mode, the communication module 120 does not respond to data sent by the communication network. For example, it does not respond to an acknowledgement of receipt of the data sent by the communication module 120. In this transmission mode, which is exclusively aimed at transmission, the transmission of data is often also referred to as unidirectional (uplink).

Since the communication module 120 can be selectively operated in transmission mode, reception mode and transmission and reception mode, the appropriate mode can be selected for the respective purpose in order to operate the tracking device 100 in the most energy-efficient manner possible. In particular, the energy consumption by the individual components of the tracking device 100 should be kept as low as possible in order to extend the operating time of the tracking device 100. The communication module 120 may further comprise an antenna. Alternatively, an antenna is suitably integrated into the base body 101 and connected to the communication module 120.

Information can be displayed visually by means of the graphic output unit 110. The graphic output unit 110 can be implemented in the form of a two-dimensional display. The graphic output unit 110 should also be bendable. For example, the graphic output unit 110 may be implemented as an e-paper display, foil display, LCD, LED or OLED. The use of such displays makes it possible to design the graphic output unit 110 to be relatively thin, so that the tracking device has a low overall thickness.

The energy source 150 may, for example, be a rechargeable battery. Preferably, non-bendable energy sources 150, for example rechargeable button cells, are used, as these are sufficiently stable and safe. The rechargeable battery can, for example, be charged contactlessly. Alternatively or additionally, it is possible that a contact device is provided in order to supply energy to the battery externally and charge it in the process. For example, a plug connection can be provided on a side edge of the base body 101 as a contact device. The plug connection can serve both to charge the energy source 150 and as a data interface.

With reference to FIG. 2, a tracking device according to a further embodiment is described, which extends the embodiment according to FIG. 1. In addition to the graphic output unit 110, energy source 150, processor module 140 and communication module 120, the tracking device 100 also has, in particular, a memory module 190 and a machine-readable code 160. The processor module 140 and the memory module 190 can also be designed as a unit, i.e. processor with integrated memory.

In the embodiment shown here, the machine-readable code 160 is in the form of a QR code, which is printed or affixed to the front of the tracking device 100. Other forms of the machine-readable code, for example as a 1D or 2D barcode, are also possible. For example, the QR code can be read optically using a mobile terminal, such as a mobile phone. The QR code encodes an identifier specific to the respective tracking device 100, with the help of which the respective tracking device 100 can be uniquely identified. The identifier can also be applied to the tracking device 100 in the form of human-readable text. Instead of a QR code, or in addition to a QR code, the machine-readable code 160 may also be stored in the form of an RFID identifier so that the machine-readable code 160 can be read by radio. For example, the tracking device 100 may have a near field communication chip in which the identifier of the tracking device 100 is stored. This identifier can be read contactlessly, for example by means of a mobile terminal. Even in the case of an RFID identifier, the identifier can also be affixed to the tracking device 100 as human-readable text.

The memory module 190 stores the instructions for the basic functions of the tracking device 100 in the form of software and data. Preferably, the memory module 190 is a non-volatile memory, for example flash memory, in order to minimise the energy requirement for storing instructions and data. The non-volatile memory can be a permanent memory or a semi-permanent memory. A permanent memory can only be programmed once and can then no longer be changed. A semi-permanent memory, on the other hand, can be reprogrammed. It is also possible to use a combination of a permanent and a semi-permanent memory. In both cases, the advantage is utilised that the memory content is retained even without a power supply.

The instructions stored in the memory module 190 are read out and executed by the processor module 140. This allows all functions of the tracking device 100 to be controlled, for example the communication module 120 and the graphic output unit 110.

Furthermore, the tracking device may have an input and output device 170 and at least one, preferably at least two, in particular at least three sensors 180. The sensors 180 may in particular be a light sensor, an acceleration sensor, a bending sensor and a rotation rate sensor. By means of these sensors, it is possible to register certain events that may occur during the transport of a shipment.

The input and output device 170 may be a data communication module. The data communication module may comprise a near-field communication module 170 and/or a short-range communication module to enable contactless communication of the tracking device 100 with an operator device or other receiver-transmitter-units. The operator device may be, for example, a mobile terminal, a charging device, or a magazine for storing a plurality of tracking devices 100. The near-field communication module 170 may comprise the near-field communication chip mentioned further above, to enable contactless reading of the machine-readable code via the near-field communication module 170. The short-range communication module may be a Bluetooth module.

Preferably, the tracking device 100 is designed such that it can perform or enables the following functions: position determination, registration of changes in movement and changes in the environment, graphical output of information, wireless communication with a communication network, provision of a contactless data interface.

In particular, the capabilities of the communication network are utilised to determine the position. Since the position of the tracking device 100 can be determined by means of the communication module 120 when communicating with the communication network, the communication module 120 provides a means for determining the position. In addition, the tracking device 100 may also have a localisation module 130 separate from the communication module 120. However, the method of determining the position differs whether the position is detected by means of the communication network or by means of the localisation module 130. In the simplest case, the functionality of the communication network is utilised, as the communication network can infer the position of the tracking device 100 upon reception of data transmitted by the tracking device 100. In this case, the tracking device 100 cannot determine its own position independently of the communication network. This is only possible if the localisation module 130 is activated, which then evaluates signals from global positioning systems (GPS, Glonass, Beidou, Galileo) and thus determines its own position.

To register changes in motion and changes in the environment, the tracking device 100 has suitable sensors, in particular one or more light sensors, one or more acceleration sensors, one or more bending sensors and/or one or more rotation rate sensors. Furthermore, the tracking device may have one or more pressure sensors for detecting the barometric pressure. Preferably, the tracking device 100 comprises at least two different sensors. For example, the tracking device 100 may have a bending sensor and an acceleration sensor.

The bending sensor can be used, for example, to register whether the shipment 230 and thus the tracking device 100 is subject to mechanical stress. Specific mechanical stresses occur, for example, within mail distribution centres when sorting shipments. For example, mail items pass through sorting machines which guide the mail items over rollers. In the process, the mail items are subjected to a certain degree of bending. At the same time, the movement along part of a circular path causes a rotational acceleration, which can be registered by a rotation rate sensor and/or acceleration sensor. Due to the time-coupled detection of bending and rotational acceleration, it can be concluded, for example, that the tracking device is currently located in a mail distribution centre.

Another combination of events that can be registered by several sensors 180 is, for example, posting in a letterbox. The ambient light conditions change, the mail item may be bent slightly when it is inserted, and the mail item is stopped abruptly when it reaches the bottom of the letterbox. The detection signals from the light sensor, the bending sensor and the acceleration sensor, for example, are used to detect these events. If these events occur at close intervals, it can be concluded that the mail item may have been deposited in a letterbox.

The graphic output unit 110 is used in particular for the graphic output of information. This can also be designed as an input unit, for example by designing areas of the graphic output unit to be pressure-sensitive and thus generate control signals when touched. Alternatively, one or more switching elements, for example in the form of membrane switches, can also be provided for operating the tracking device 100. In addition, an optical display device 195, for example in the form of an LED, can be provided for signalling certain events, for example successful activation. This is shown in FIG. 2, for example.

In particular, the communication module 120 is used for wireless communication with a communication network. Taking into account the lowest possible energy consumption and long runtime of the tracking device 100, the communication module 120 is designed in particular for communication with low power WAN networks.

The data communication module 170, for example the near-field communication module, which may have an RFID chip, for example, is used in particular to provide a contactless data interface. The data communication module 170 can be used to read data from the tracking device 100, in particular from the memory 190 or other special memory chips, and store it if necessary. In addition, the software stored in the memory 190, which is provided for the operator of the tracking device 100, can be updated. The unique identifier or machine-readable code 160 may be stored in the memory 190 or in a special RFID chip.

Since each tracking device 100 has a unique identifier in the form of a machine-readable code, this code should not be stored in a way that can be overwritten. Communication with an operator device or other devices can be contactless via the data communication module 170.

Furthermore, the tracking device 100 may comprise a circuit board, not shown here, which carries all the essential electronic components and modules and makes the corresponding electrical connections between the individual components and modules. An antenna can also be integrated into the circuit board.

The described components of the tracking device 100 are integrated into the flat base body 101. The opposing side surfaces of the base body 101 are preferably flat, i.e. individual components do not protrude beyond the side surfaces. For example, it is possible to embed the individual components in a plastic material, which forms the base material of the base body 101. Examples of suitable plastic materials are polyimide. Furthermore, it is possible to manufacture the base body 101 in the form of a laminate of different layers, with individual layers assuming different functions. For example, the outer layers can each serve as a protective layer to protect layers further inside from moisture and dirt. One of the inner layers can, for example, take on the function of a wiring layer in order to electrically connect the individual components to one another. The base body 101 can, for example, be incorporated into commercially available laminating films. Alternatively, it is possible for the base body 101 to have a paper surface on one or both sides.

Embedded in the base body 101, or forming a part of the base body 101, a fully flexible conductor track made of, for example, polyimide or a rigid-flex circuit board made of, for example, FR4 (flame-retardant composite material made of epoxy resin and glass fibre fabric) can be provided. In order to ensure sufficient flexibility of the rigid-flex circuit board, it can have a thickness of about 200 μm to about 500 μm, preferably about 250 μm to 400 μm, and for example about 300 μm.

With reference to FIG. 3, a method for tracking shipments according to one embodiment is explained. The previously described tracking devices 100 may be used for tracking shipments. With this method, a user 201, which is hereinafter referred to as the first user, can send shipments to one or more recipients 211 and thereby monitor the progress of the shipment until reception at the recipient 211 by means of one of the tracking devices 100. For this purpose, the first user 201 adds a tracking device 100 to the respective shipment.

The process specifically shown in FIG. 3 illustrates the progression of a shipment 230 from the first user 201 to a recipient 211, as well as the onward forwarding of a tracking device from the recipient 211 to a second user 202 who has a need for tracking devices. The diagram in FIG. 3 is intended to explain, but is not limited to, some aspects of the method.

As indicated in FIG. 3, the first user 201 has a plurality of tracking devices 100 which have been provided to the first user 201 by an operator not shown here. The operator has further provided a control unit 210, which can communicate independently with the individual tracking devices 100 via a communication network 220. The communication is indicated in FIG. 3 by means of the dotted arrows, whereby the communication can be unidirectional or bidirectional depending on the state of the tracking device and the current situation.

The first user 201 wants to send a shipment 230 to the recipient 211 and thereby track the progress of the shipment during transport. At the same time, the first user 201 wishes to enable the recipient 211 to also track the progress of the shipment 230. For this purpose, the first user 201 uses one of the tracking devices 100 provided to him by the operator. In the simplest case, the first user 201 only has a single tracking device 100 as he only wishes to send a single shipment 230. However, in a typical use case, the first user 201 has a plurality of tracking devices 100 from which he selects any one tracking device to track the shipment 230.

The shipment may be a postal item, a forwarding item or a courier item, or any other item whose progress is to be tracked. Since the tracking devices 100 have a flat shape and are rather thin, a tracking device 100 can also be used for tracking letter mail.

Before the first user 201 attaches a tracking device 100 to the shipment 230, the tracking device 100 is first activated. The activation initially transfers the tracking device 100 from an idle state to an operating state or from an off state to the operating state. An activated tracking device 100a is then present. Successful activation can be indicated by the LED 195. For the transfer to the operating state, the tracking device 100 can, for example, be supplied with energy, for example by placing the tracking device 100 on a charging device in order to charge the rechargeable energy source 150 of the tracking device 100 without contact. Alternatively, it is possible that the tracking device 100 has been provided to the first user 210 by the operator already charged, so that the tracking device 100 is for example in an idle state before it is activated.

Furthermore, it is possible that the tracking device 100 has a switching element, upon actuation of which by the first user 201 the tracking device 100 can be transferred either from the off state to the operating state or from the idle state to the operating state. Depending on the current state in which the tracking device 100 is, different functions can be triggered when the switching element is actuated. For example, it is possible for a tracking device 100, which is in an operating state, to be transferred to the off state or the idle state when the switching element is actuated. As will be explained later, when the shipment 230 is received, the recipient 211 can acknowledge the reception of the shipment 230 by actuating the switching element.

The tracking device 100 may also be automatically activated upon removal from a charging device, or upon removal or dispensing from a magazine for storing a plurality of tracking devices. Such a magazine may also have a charging device, for example a contactless charging device, with which the individual tracking devices 100 are charged without contact when stored in the magazine. Both placing on a charging device and removing from the charging device leads to a change that can be registered by the tracking device 100 (charging current ON or charging current OFF), which can be used to automatically activate the tracking device 100. Furthermore, when the tracking device 100 is removed or dispensed from the magazine, the tracking device 100 can be guided past an RFID read head, which on the one hand reads out the identifier specific to the tracking device 100 and on the other hand emits a signal to the tracking device for its activation. RFID read heads can also be integrated in the charging devices and thus enable automatic communication with the tracking device 100.

The successful activation of the tracking device 100a may be displayed to the first user 201, for example, on the graphic output unit 110 or an optional further optical output unit, for example an LED. Alternatively or additionally, it is possible for the tracking device 100a to transmit the activation to the control unit 210 via the communication module 120 and the communication network 220, from which the first user 201 can then query the activation.

If the activation takes place by placing or removing the item on the charging device or removing or dispensing it from the magazine, the tracking device 100 can also report its activation without contact to the charging device or the magazine, which then forward the information about the activation to the control unit 210.

The method described here can also be integrated into a dispatch system in which, for example, shipments are automatically packed and dispatched. In this case, tracking devices 100 can be automatically fed to the shipments and activated at the same time.

After the tracking device 100 has been suitably activated and is now present as an activated tracking device 100a, according to one embodiment, an assignment of the activated tracking device 100a to the specific shipment 230 which is to be sent to the recipient 211 takes place. The shipment 230 is assigned a unique shipment identifier, which is linked to the identifier of the tracking device 100. The unique shipment identifier is either assigned by the first user 201 or is received from a carrier to whom the first user 201 hands over the shipment for transport to the recipient 211. The assignment of the unique shipment identifier and the identifier of the tracking device 100 is transmitted to the control unit 210, so that the assignment is known to the system. The position of the assigned shipment 230 can then also be deduced by querying the position of the tracking device 100.

The assignment of the unique shipment identifier of the shipment 230 and the identifier of the tracking device 100 can take place before activation or after activation of the tracking device 100. Preferably, however, the assignment is made after activation, as this enables contactless reading of the identifier of the tracking device. For example, the first user 201 can read out the identifier of the activated tracking device 100a contactlessly by means of a suitably equipped operator device. Similarly, the operator device can be used to receive the shipment identifier from the carrier or to read it in by the first user 201. In one possible application, the operator device is a mobile terminal, for example a mobile phone or a tablet, on which suitable software, for example a specific app (software application), is installed, whereby the mobile terminal is set up to communicate contactlessly via the data communication module 170 (for example near-field communication or Bluetooth) with the activated tracking device 100a and to optically read in a shipment identifier printed or affixed to the shipment 230, for example. The assignment of the identifier of the tracking device 100a to the shipment identifier is then carried out by the software in the mobile terminal, which can simultaneously establish contact with the control unit 210 in order to transmit this assignment to the control unit 210.

For example, if the first user 201 uses a dispatch system with automatic packaging of the shipments, the assignment of the shipment identifier and identifier of the activated tracking device 100a can also take place automatically when the tracking device 100a and shipment 230 are physically brought together. The assignment can then also be automatically transmitted from the dispatch system to the control unit 210. The automatic assignment can be carried out, for example, by feeding the tracking device 100a in the dispatch system to a device (parcel labelling station) for attaching a shipment label to the outside of a shipment 230 and this device has a Bluetooth receiver-transmitter-unit specific to this device or one or more Bluetooth receiver-transmitter-units are arranged in the vicinity of this device, which detect or capture signals from the data communication module 170 (Bluetooth module). The Bluetooth receiver-transmitter-unit can read the identifier of the tracking device 100a without contact and transmit it, together with the shipment identifier, to the control unit 210. Alternatively, the dispatch system can also have a separate station for this assignment with at least one further Bluetooth receiver-transmitter-unit, or with one or more Bluetooth receiver-transmitter-units in the vicinity of this separate station, as well as an optical detection device, in which both the applied shipment identifier can be read in optically and the unique identifier can be interrogated without contact.

When the activated tracking device 100a is assigned to a shipment 230, the tracking device 100a is in a transmission state. This transmission state denotes the period of time from the assignment of tracking device to the shipment until the recipient 211 receives the shipment and, in particular, until the recipient 211 has acknowledged the receipt or the receipt has been automatically registered by the tracking device 100a. Within this period, the recipient 211 and/or the first user 201 and/or the operator may request the position of the tracking device 100a from the control unit 210 in order to thereby obtain the current position of the shipment 230. After the shipment 230 has arrived at the recipient 211 and the receipt has been suitably registered, the assignment between the shipment identifier and the identifier of the tracking device 100a is cancelled, in which case the recipient 211 can no longer query the position of the tracking device 100a. The first user 211 can still track the position, in particular to recognise the forwarding that has taken place and to credit a possible bonus to the recipient. The operator can also continue to track the position.

Certain functions of the tracking device 100a may only be activated in the transmission state, for example the acquisition of data by the sensors 180 or the acquisition of the position by the localisation module 130. In addition, it may be provided that the tracking device 100a makes contact with the communication network more frequently in the transmission state than in the idle state or operating state, since in the transmission state the position of the tracking device 100a is queried more regularly by the control unit 210 via the communication network. However, it is also possible that the tracking device 100a contacts the communication network 220 with the same frequency both in the operating state and in the transmission state.

The first user 201 physically brings together the activated tracking device 100a, which has been assigned to the shipment 230, and the shipment 230, in particular the first user 201 includes the tracking device 100a in the shipment 230. In the case of mail items, the tracking device 100a is inserted into the envelope. In the case of parcel shipments, the tracking device 100a may also be placed inside the parcel or suitably attached to the outside. This also applies to courier shipments. It is only essential that the tracking device 100a is sufficiently firmly and securely connected to the shipment 230 for the purposes of transporting the shipment 230, so that the tracking device 100a does not become detached from the shipment 230.

In FIG. 3, a shipment 230 with an activated tracking device 100a enclosed is indicated, wherein the tracking device 100a contained in the shipment 230 is shown dashed. The shipment 230 is then transported by a carrier 250 together with the tracking device 100a to the recipient 211. During this time, the control unit 210 repeatedly receives the position of the activated tracking device 100a during the transport of the shipment 230 to the recipient 211, in particular by querying the current position at the communication network 220. This makes it possible for the first user 201 and the recipient 211 to query the position of the shipment 230 via the control unit 210. The first user 201 can make this query, for example, via his mobile terminal on which the specific app described above is executed. Alternatively or additionally, a web interface can be provided by the operator of the control unit 210, which outputs the current position of the shipment 230 after entering the shipment identifier or the identifier of the tracking device 100a, possibly with additional entry of the receiving address or parts thereof (e.g. only postcode).

In addition or as an alternative to periodic communication between the tracking device 100a and the communication network 220, the tracking device 100a may contact the communication network 220 after specific events have been detected. To recognise these specific events, the sensors 180 are regularly interrogated or signals are emitted by the sensors 180 as soon as certain changes are detected.

The detected signals from the sensors 180 are analysed by the software of the tracking device 100a and assigned to predetermined events when certain patterns are detected. As explained above, the insertion of the shipment 230 into a mailbox may include certain events which are characterised by (virtually) simultaneous occurrence of a change in brightness from light to dark, bending and abrupt stopping.

Classic signal processing methods, methods from the machine learning field such as SVM (support vector machines) and even optimised neural networks can be used to recognise predetermined events. Support vector machines describe mathematical methods for pattern recognition, which can be computer-implemented, for example. SMVs can also be regarded as part of machine learning. Alternatively, it is possible that a rule-based system for recognising the predetermined events is stored in the memory 190.

Additionally or alternatively, the tracking device 100a can determine its own position periodically or when certain events are detected by means of the localisation module 130 and transmit it to the control unit 210.

Furthermore, it is possible that base stations and/or repeaters are installed in distribution centres of the carriers 250 and/or in vehicles of the carriers 250, via which the tracking device 100a can query or determine its own position. For example, a base station of the communication network 220 may be installed in a distribution centre, with which the tracking device 100a then communicates.

The tracking device 100a can also activate the localisation module 130 only when predetermined events are detected by the sensors 180 or when the target area is reached. To recognise the target area, according to one embodiment, it is sufficient for the tracking device 100a to be able to recognise its approximate location. Communication with the communication network 220 is often sufficient for this purpose. Alternatively, the localisation module 130 can also be activated by the control unit 210 if, after querying the location of the tracking device 100a, it detects that the tracking device 100a is approaching the target area of the recipient 211 or is already in the target area. The control unit 210 then sends a corresponding control signal to the tracking device 100a.

The tracking device 100a may also periodically activate the localisation module 130 after a time interval has elapsed. For example, the localisation module 130 may be activated for a period of time 24 hours after shipping.

After activation of the localisation module 130, the tracking device 100a can then determine its exact position and transmit it to the control unit 210. This allows both the first user 201 and the recipient 211 to be informed of the exact location of the tracking device 100a, and thus of the shipment 230. The recipient 211 can then take action to receive the shipment 230 or inform the carrier 250, via the control unit 210, where to deliver or deposit the shipment 230 if the recipient 211 is unable to receive the shipment 230 in person. The carrier 250 may communicate directly with the control unit 210 via other communication networks and is not limited to the communication network 220. This is indicated by the dash-dotted arrow.

After receipt of the shipment 230 by the recipient 211, the recipient 211 removes the tracking device 100a from the shipment 230 and acknowledges the receipt, for example by activating the switching element or by means of the app running in the recipient's mobile terminal, whereby the recipient places the mobile terminal on the tracking device to acknowledge receipt, thereby effecting an NFC data exchange. Since the tracking device 100a was in the transmission state, the actuation of the switching element is interpreted as confirmation of receipt on the part of the recipient 211, but the tracking device 100a is not switched off.

The acknowledgement of the receipt is transmitted to the control unit 210 and communicated to the first user 201. This can take place, for example, via the communication network 220 or, for example, via a mobile terminal of the recipient 211, which executes the app already described above or an app.

The recipient 211 now sends the tracking device 100a on without the shipment 230. For this purpose, the graphic output unit 110 can first inform the recipient 211 that he should first deposit the tracking device 100a in a mailbox or deliver it to a return station provided for this purpose.

Specifically, after acknowledging the receipt of the tracking device 100a, a first destination instruction may be transmitted, for example, which causes a first destination address information to be displayed on the graphic output unit 110 for further transmission of the tracking device 100a. The first destination instruction may include, for example, a general instruction to deposit the tracking device 100a in a mailbox. For example, the recipient 211 may be provided with a list of several mailboxes in his vicinity or nearby drop-off machines. Based on the sensors 180 present, the tracking device 100a can detect whether it has been deposited into a mailbox. If the tracking device 100a is fed to a return machine, the return machine can record the return or transmit this information contactlessly to the tracking device 100a and/or to the control unit 210.

After the tracking device 100a has been deposited in a mailbox or delivered to a return machine, a second destination instruction may be transmitted to the tracking device 100a to cause second destination address information to be displayed on the graphic output unit 110 for further transmission of the tracking device 100a. The second destination address information may be the address of a second user 202 who currently has a high demand for tracking devices 100. This makes it possible to send a previously used tracking device 100 in a targeted manner to where there is currently an increased demand. A return to a distribution centre operated by the operator is not necessary, so that the tracking device 100a which the recipient 211 has received can be reused relatively quickly.

By means of the control unit 210, the operator can monitor the stock levels of tracking devices 100 at the individual users. For a better explanation, reference is made below to FIG. 4.

In FIG. 4, the operator is denoted by 321, which supplies the tracking devices 300 to the individual users 301, 302 and 303 upon request. For example, the users 301, 302, 303 of the tracking system have entered into a contractual agreement with the operator 321 for the provision of tracking devices 300. The operator 321 then provides the desired amount of tracking devices 300 to the individual users 301, 302, 303. In addition, the individual users 301, 302, 303 may agree with the operator 321 on a minimum quantity of tracking devices 300 that the individual users 301, 302, 303 should not fall below. The minimum quantity may, of course, be different for the individual users 301, 302, 303.

The individual users hand over shipments, which are addressed to recipients, to a carrier not shown in FIG. 4, as described above. For this purpose, the users each activate a tracking device 300, assign the activated tracking device 300 to the shipment, and enclose the activated and assigned tracking device 300 with the shipment before handing it over to the carrier. In FIG. 4, the sending of a shipment together with a tracking device 300 is shown by the hatched thick arrows. The communication between the tracking devices and the control unit 310 is indicated by thin dashed arrows. In contrast, the onward transmission of the tracking devices 300 without shipment from the recipients to respective users is indicated by the unfilled thick arrows.

For example, the user 301, hereinafter the first user 301, sends a shipment together with a tracking device 300 to a first recipient 311. A second user 302 sends another shipment together with a tracking device 300 to a second recipient 312. A third user 303 in turn sends another shipment together with a tracking device 300 to a third recipient 313. As indicated in FIG. 4, the third user 303 has only a low stock level of tracking devices 300 compared to the first user 301 and the second user 302. However, it is assumed here that the third user 303 has a high demand for tracking devices 300 that exceeds its current stock level. For example, the current stock level of tracking devices 300 at the third user 303 may be less than the agreed minimum stock level, or the third user 303 may have a higher demand for tracking devices 300 at short-term and has reported this higher demand to the operator 321.

The operator 321 knows the current stocks of tracking devices 300 at the individual users and also knows the number of tracking devices 300 currently in use for tracking shipments. Specifically, this overview can be called up, for example, in the control unit 310 for the operator 321. If the operator 321 now recognises, or if the control unit 310 automatically recognises, that the third user 303 has an acute need for tracking devices 300, the control unit 310 can transmit destination instructions to the tracking devices 300 which have just arrived or will soon arrive at the recipients 311, 312 and 313, which then lead to the output of destination address information for forwarding the respective tracking device 300 to the third user on the graphic output unit. This allows additional tracking devices 300 to be sent to the third user 303 relatively quickly.

As can be seen in FIG. 4, the first recipient 311 and the second recipient 312 do not send the received tracking devices 300 back to the first user 301 and the second user 302 respectively, but to the third user 303. The third recipient 313, who has received a shipment from the third user, is requested by the control unit 310 to send the tracking device back to the third user 303.

The situation shown in FIG. 4 is merely illustrative of some aspects of the method described herein, without being limited thereto. For example, if the second user 302 also has a high demand for tracking devices 300, even if the third user 303 already has a high demand for tracking devices 300, the control unit 310 may cause, for example, the first recipient 311 to send the tracking device 300 that has arrived at the first recipient to the second user 302 and not to the third user 303.

When evaluating which tracking device 300 should be sent to which user, the control unit 310 may take into account the spatial distribution of the recipients 311, 312, 313 and the users 301, 302, 303 in addition to the current demand and the stock level of tracking devices 300 at the individual users. For example, if the spatial distance between the first recipient 311 and the second user 302 is small, but between the first recipient 311 and the third user 303 is large, then it is suitable, for example, to send the tracking device 300 from the first recipient 311 to the second user 302, even if the demand from the third user 303 should be higher. The control unit 310 is therefore preferably configured such that it optimises the forwarding of the tracking devices from the individual recipients to the users, taking into account the spatial distance and the current demand. Of course, the spatial distance also has an influence on how quickly a tracking device can reach a user.

However, a recipient can also be a user. In this case, it is also taken into account whether the user who is currently receiving a tracking device from another user by means of a shipment has a need for further tracking devices or not. If this user (who has just received the shipment) has a need, then no destination instructions are transmitted to the tracking device or only a message is transmitted that the tracking device can remain with this user. If, on the other hand, this user has no current need for further tracking devices, then a destination instruction can be transmitted to the tracking device for forwarding the tracking device to another user.

In order to reliably determine the stocks at the individual users, according to one embodiment it may be provided that the tracking devices 300, which are in stock at the individual users, transmit their status to the control unit 310 at regular intervals. This can be done once a day, for example, by sending a short data packet. At the same time, the control unit 310 can thereby verify the location of the individual tracking devices via the communication network not shown in FIG. 4 and check whether the tracking devices provided to a particular user are actually still in stock with that user. This makes it possible to carry out a regular or continuous inventory of the tracking devices.

In the case of users who regularly use a relatively large number of tracking devices 300, it is suitable for the operator 321 to provide them with suitable apparatus for storing and dispensing tracking devices 300. Such apparatus may be, for example, the magazines described above. The apparatus may be designed such that the information about the stock level of tracking devices is also transmitted from the apparatus to the control unit 310. To this end, the devices may, for example, comprise suitable reading devices for contactless communication with the tracking devices 300 stored in the apparatus. At the same time, the apparatus may comprise suitable charging devices for contactless charging of the tracking devices.

Such an apparatus using the example of a magazine is shown, for example, in FIG. 5. For this purpose, the apparatus 400 can have, for example, a transport apparatus 420 with which the individual tracking devices 410 can be moved up to an output compartment at which a removal takes place. At the same time, the apparatus 400 has a charging device 430 and a reading device 440 for contactless communication with the individual tracking devices 410. The reading device 440 can, for example, communicate with the control unit via a communication interface of the magazine, which is connected to a data connection 441 schematically indicated here, in order to transmit the current stock level to the control unit. The charging device 430 can be supplied with energy via a charging cable 442.

Another way of transmitting the current stock level of tracking devices to the control unit is to use a mobile terminal, for example a mobile phone 500, as shown in FIG. 6. For example, suitable software (app) can be installed and executed on the mobile phone 500. This software is provided, for example, by the operator of the tracking system.

For this purpose, the user can bring the mobile phone 500 in close proximity to the tracking device 510 so that the mobile phone 500 can communicate contactlessly with the near-field communication module of the tracking device 510. For example, the unique identifier of the tracking device 510, referred to here as TrackerID, can be read out and displayed on the mobile phone 500. At the same time, the charge state of the rechargeable battery can be displayed. Under the entry ‘Assigned to Shipment Number’, the shipment identifier would be displayed if the tracking device 510 were assigned to a specific shipment. This is not the case in the present embodiment example, as it is only a matter of checking the stock level at the respective user.

The software installed on the mobile terminal 500 can furthermore be set up to optically detect and decode the shipment identifier, for example labelled or printed on a parcel, using the camera of the mobile terminal 500, which is not shown here, so that the shipment identifier can then be assigned to the TrackerID of the tracking device 510 before handover to the carrier. This assignment can then be transmitted directly from the mobile terminal 500 to the control unit.

FIG. 7 shows a charging device 700 for contactless charging of a tracking device 710. The tracking device 710 is simply placed on the charging device 700 and is then charged inductively. In addition, NFC communication can also be established between charging device 700 and tracking device 710. Energy is supplied to the charging device 700 via a charging cable 720. By means of a communication interface, which is connected to a data connection 730, the charging device 700 can communicate with the control unit 210 via a suitable data network and exchange data. Instead of NFC communication, Bluetooth communication can also be established between charging device 700 and tracking device 710. Bluetooth communication allows a higher data transmission rate than NFC and is therefore more suitable for installing a software update.

FIG. 8A schematically shows a transport container 800 with a tracking device 810 detachably attached thereto. FIG. 8B shows a transport container 805 in the form of a transport trolley with a tracking device 810 detachably attached thereto.

In principle, any container, trolley or container that is suitable for repeatedly picking up and removing transport goods and ensures sufficiently safe transport of the transport goods can serve as a transport container. FIGS. 8A and 8B only show typical examples.

The transport container 800 or 805 is used to move transport goods, for example various boxes or small parts (not shown), from a first location to a second location. After reaching the second location, the transport goods are removed from the transport container 800, 805. Depending on the demand and the spatial distribution of individual locations at which transport containers 800, 805 are required, the control unit transmits suitable destination instructions to the individual tracking devices 810, analogous to the embodiments described above. In this way, the transport containers 800, 805 can be transferred to the locations at which there is currently a high demand for transport containers.

FIG. 9 schematically shows a dispatch system 900 with a parcel labelling station B and a station in which the assignment between unique identifier and shipment identifier is carried out using Bluetooth receiver-transmitter-units. The dispatch system 900 comprises a transport apparatus 905, for example a conveyor belt 905, which moves the individual shipments 930 from station to station. The movement is indicated here by the arrow pointing to the right. At packing station A, a tracking device 910 is attached to a shipment 930, in the present embodiment example a parcel. This can be done automatically or manually. The parcel is then sealed. By means of the transport apparatus 905, the parcel 930 is then moved to a parcel labelling station B. There, a parcel label 935 is printed on the parcel 930 by means of a printer or a parcel label is affixed by means of an applicator. Printer or applicator are indicated by 940. The parcel label contains the destination address and a shipment identifier 935, in the embodiment shown here as a barcode. Other machine-readable codes are also possible.

Bluetooth receiver-transmitter-units 920b, which receive signals (data packets) from the tracking device 910, can be arranged in the immediate vicinity of the parcel labelling station B. Based on the spatial distribution of the Bluetooth receiver-transmitter-units 920b, the position of the tracking device 910 can be clearly inferred and it can be localised in the parcel labelling station B.

After the parcel 930 has been provided with the parcel label 935, the parcel 930 is moved to an assignment station or verification station C by means of the transport apparatus 905. There, the parcel label is optically detected and the shipment identifier 935 is read out. It can be checked whether the parcel label can be reliably detected optically or whether it was not printed or applied correctly in the parcel labelling station B. In addition, Bluetooth receiver-transmitter-units 920c, which receive signals (data packets) from the tracking device 910, can be arranged in the immediate vicinity of the assignment station/verification station C. Based on the spatial distribution of the Bluetooth receiver-transmitter-units 920c, the position of the tracking device 910 can be clearly inferred and it can be localised in the assignment station C. This makes it possible for both the shipment identifier 935 of the parcel 930 (the shipment) and the unique identifier of the tracking device 910 to be recorded and assigned to each other in the assignment station C. This assignment is carried out automatically by the dispatch system and is transmitted to the control unit.

Alternatively, it is possible for the parcel label to be visually captured but the shipment identifier not read. The parcel label is then only detected to check whether the parcel label can be detected optically. The position of the parcel 930 can also be determined by other means or is known to the dispatch system, as the parcel labelling station B must also already know which parcel 930 is currently at the parcel labelling station B. In principle, the logical position of the individual parcels in a dispatch system is known by the transport speed and dwell time at the individual stations. Explicit optical detection and reading of the shipment identifier is therefore not necessary.

With reference to FIG. 10, a method for tracking and redistributing transport containers 1000, 1001 between different locations is described. Specifically, three locations S1, S2 and S3 are shown in FIG. 10, without being limited thereto. The three locations S1, S2 and S3 each currently have a different stock level of empty transport containers 1000. The transport containers 1000, 1001 are all identical in the present embodiment example, i.e. they belong to the same class of transport containers.

The transport containers are used to transport goods to other locations. In the present embodiment example, transport containers in which a transport goods is accommodated are labelled 1001, while empty transport containers are labelled 1000. A transport container 1001 is used to move a transport good 1013 from the location (first location) S1 to the location (second location) S2, and another transport container 1001 is used to move another transport good 1012 from the location (third location) S3 to the location S1, indicated by the hatched thick arrows.

Each transport container 1000, 1001 has a tracking device 1010 which is, for example, detachably attached to an outside of the respective transport container 1000, 1001. The tracking devices 1010 may be the tracking devices described further above. In the present embodiment example, the tracking devices 1010 have an energy source not shown here, a processor module, a memory module, a communication module and a data communication module. Optionally, the tracking devices may also have a graphic output unit, sensors and a localisation module. In particular, the data communication module may be a Bluetooth module.

During the transport of the transport containers 1001, the tracking devices 1010 are in connection with the control unit 210, as already described in detail above. This also takes place via a communication network not shown here, as described further above. As a result, the position of the tracking devices 1010 and thus of the transport containers 1001 can be determined and tracked. Similarly, the tracking devices 1010 of the currently unused empty transport containers 1000 can communicate or be in connection with the control unit 210, indicated here by thin dashed arrows, analogous to the tracking devices described above, which are not yet activated, so that the control unit 210 can check the inventory of empty transport containers 1000 at regular intervals.

Since the tracking devices 1010 are attached to the individual transport containers 1000, 1001, the tracking devices 1010 can also be made larger and in particular have a larger capacity energy source. This allows the tracking devices 1010 to remain permanently activated, which enables comparatively frequent communication with the control unit 210.

In addition, a plurality of receiver-transmitter-units 1020, which are preferably Bluetooth receiver-transmitter-units, are installed at each of the locations S1, S2 and S3. These can communicate contactlessly with the data communication module of the tracking devices 1010. As a result, the position of the individual tracking devices 1010, and thus of the transport containers 1000, 1001, at the individual locations S1, S2 and S3 can be determined and transmitted to the control unit 210, as described, for example, specifically in connection with FIG. 9.

As indicated in FIG. 10, the stock level of empty transport containers 1000 at location S3 is significantly lower than, for example, at location S2. The stock level is indicated by the height of the empty transport containers 1000 stacked on top of each other. The control unit 210 monitors the stock and the demand for transport containers 1000 at the individual locations. Since in the present embodiment the location S3 has a low stock level of transport containers 1000, which may correspond to an increased demand for transport containers 1000, instructions for sending empty transport containers 1000 are generated by the control unit 210 and transmitted, for example, to the location S2. These instructions are registered there, for example by a dispatcher not shown here. The dispatcher then arranges for empty transport containers 1000 to be transported to location S3 based on the instructions generated. In the specific embodiment example, three empty transport containers 1000 are transported to location S3, indicated by the unfilled thick arrow.

Information on the position of the empty transport containers 1000 can be transmitted to the control unit 210 via the receiver-transmitter-units 1020. This enables the control unit 210 to monitor whether the empty transport containers 1000 have been fed to an outgoing goods department of location S2, for example, in accordance with the instructions issued, or whether these empty transport containers 1000 have already arrived at the incoming goods department of location S3.

In principle, therefore, the tracking system described herein can be used to track transport containers 1000, 1001 and efficiently effect the distribution of empty transport containers 1000 to locations that currently have a high demand for transport containers 1000. The advantages achieved with the tracking of shipments and redistribution of the tracking devices utilised in this process also apply to the method of tracking and redistributing transport containers.

In the method for tracking and redistributing transport containers, the control unit 210 may also be controlled by the company using the transport containers. The control unit 210 therefore does not have to be, but can be controlled by an external operator.

With reference to FIG. 11, a further embodiment of a tracking device 2000 is explained, which can be implemented with any other embodiment described herein alone or in any combination. The following description should therefore be seen in conjunction with the description of the above embodiments.

The tracking device 2000 has at least one circuit board, preferably two circuit boards, each of which is an independent tracking device, i.e. can be used individually as a tracking device. In addition, it is possible to use both circuit boards together as a common tracking device. To do this, the two circuit boards are electrically connected to each other.

Specifically, the tracking device 2000 can have, for example, a first circuit board 2100 and a second circuit board 2200, which are electrically connected to each other via, for example, a flexible connection 2105, such as a flexible plug-in connection. The electrical connection allows, on the one hand, an exchange of data between the two circuit boards and, on the other hand, an additional power supply to the first circuit board 2100 by the second circuit board 2200. The flexible plug connection 2105 can be a flexible ribbon cable with connectors. Alternatively, a detachable plug connection can also be provided.

The first circuit board 2100 has a flat first base body 2101 which has a length to thickness ratio of at least 20:1, preferably of at least 30:1, and a thickness between the two opposite side surfaces of no more than 0.5 cm, preferably of no more than 0.3 cm, and in particular of no more than 0.2 cm, especially no more than 0.1 cm, for example no more than 0.5 mm. The first base body 2101 is therefore relatively flat (small thickness), so that it allows multiple elastic bending. This is advantageous when tracking mail items which are guided through mail sorting machines and temporarily bent in the process. The first base body 2101 can absorb the resulting bends without damage. The elastically bendable first base body 2101 can, for example, have an elastic deflection of at least 20%, relative to the length of the first base body 2101. For example, the first base body 2101 may be longer than it is wide (length is greater than width), for example at least twice as long as it is wide. For example, the length may be between 8 cm and 12 cm, preferably between 8 cm and 11.5 cm. For example, the width can be between 2 cm and 5 cm, preferably between 3 cm and 4 cm. The above length and width ranges can be combined with each other as desired, i.e. the length can be between 8 cm and 12 cm and the width can be between 2 cm and 5 cm or between 3 cm and 4 cm, or the length can be between 8 cm and 11.5 cm and the width can be between 2 cm and 5 cm or between 3 cm and 4 cm.

The deflection results from the central deflection, compared to the unloaded situation, in relation to the length. If, for example, the length of the first base body 2100 is 10 cm, then a deflection of 20% means a central deflection of 2 cm when the two ends of the first base body 2100 are held firmly. The first base body 2101 may also have an elastic deflection of at least 25%, preferably at least 30%, relative to the length of the first base body 2101.

As already explained above in connection with the base body 101, a flexible but dimensionally stable material can also be used for the first base body 2101. In particular, the material from which the first base body 2101 is formed is bendable, so that the first base body 2101 and thus the first circuit board 2100 as a whole is bendable.

It is also possible, as already explained above, that in the first base body 2101, or forming a part of the first base body 2101, a fully flexible conductor track made of, for example, polyimide or a rigid-flex circuit board made of, for example, FR4 (flame-retardant composite material made of epoxy resin and glass fibre fabric) can be provided. In order to ensure sufficient flexibility of the rigid-flex circuit board, it can have a thickness of about 200 μm to about 500 μm, preferably about 250 μm to 400 μm, and for example about 300 μm.

The first circuit board 2100 further comprises a communication module 2120 to establish wireless communication with a communication network, a first memory module 2190, a first processor module 2140, at least two sensors 2180, wherein one sensor is an acceleration sensor (accelerometer) and another is a rotation rate sensor (gyrometer), a first unique identifier 2160, optionally a first optical display device 2195, and a first rechargeable energy source 2150. These components may be the components already described above, so that reference is made to the above description of these components. Optionally, the first circuit board 2100 may comprise further sensors, such as one or more bending sensors and/or one or more sensors for detecting environmental conditions.

The communication module 2120, the memory module 2190, the processor module 2140, the at least two sensors 2180, and the first rechargeable energy source 2150 are arranged on the first base body 2101. These components may also be partially integrated into the first base body 2101. Typically, however, these components are arranged and attached on the first base body 2101, i.e. on one of the two side surfaces of the first base body 2100 or also distributed on both side surfaces.

The communication module 2120 may in particular be the communication module described above as the first communication module (long-range communication module), which is in particular set up to communicate with a low power WAN communication network. In connection with the first circuit board 2100, communication modules 2120 that can communicate with LoRaWAN and Sigfox communication networks are particularly preferred. Communication with these communication networks is particularly energy-saving, which is why the first circuit board 2100 can also be compact and very lightweight. In particular, the first circuit board 2100 has a total weight of no more than 10 g. The total weight refers to the weight of the first base body 2101 and all components attached thereto.

Electrical connections, for example conductor tracks, are further provided in or on the first base body 2101 for electrically connecting the individual components. These electrical connections are not shown separately.

Preferably, the tracking device 2000 does not have a graphic output unit, i.e. no graphic output unit is arranged on the first circuit board. This further reduces the energy requirement.

Specifically, the sensors 2180 can be a 3D acceleration sensor (accelerometer for all three spatial directions) and a 3D rotation rate sensor (gyrometer for all three spatial axes).

Acceleration sensors and rotation rate sensors can also be referred to as sensors for detecting a state of motion. Furthermore, a bending sensor may also be provided on the first circuit board 2100. A bending sensor is also understood as a sensor for detecting a state of motion.

Optionally, a sensor for detecting ambient conditions may further be present on the first circuit board 2100, ambient conditions being understood to mean, in particular, humidity, air pressure and temperature. At least one sensor for detecting one of these ambient conditions may be present. Preferably, a humidity sensor, an air pressure sensor and a temperature sensor are present. These can be integrated in a common sensor chip. It is also possible that the rotation rate sensor(s) and/or the acceleration sensor(s) are integrated in a common chip. An example of a jointly integrated 3D acceleration sensor and 3D rotation rate sensor is LSM6DSOX from STMicroelectronics. An example of a jointly integrated humidity sensor, an air pressure sensor and a temperature sensor is BME280 or BME680 from Bosch.

According to a further embodiment, which can be implemented with any other embodiment described herein alone or in any combination, the tracking device 2000 comprises a second circuit board 2200. The second circuit board 2200 may in principle have the same or a similar structure as the first circuit board 2100. The second circuit board 2200 can therefore have a second base body 2201, which can be made of the same material with the same properties (same thickness ranges, same thickness to length ratio, dimensionally stable, elastically bendable) as the first base body 2101.

Furthermore, the second circuit board 2200 comprises a further communication module 2220 to establish wireless communication with the or a further communication network 220, a second memory module 2290, a second processor module 2240, at least two sensors 2280, one sensor being a light sensor and another being a rotation rate and/or acceleration sensor a second unique identifier 2260, optionally a second optical display device 2295, optionally a short-range communication module, for example a Bluetooth module 2270, optionally a localisation module, in particular a GPS and/or a Glonass and/or a Beidou and/or a Galileo module 2230, and a second rechargeable energy source 2250.

The processor modules, memory modules and optical display devices can be the same on the first and second circuit boards.

Preferably, the second rechargeable energy source 2250 has a larger capacity than the first rechargeable energy source 2150, so that the second circuit board 2200 also allows the use of components which have a higher energy requirement. In particular, the further communication module 2220 may therefore be a different communication module than the first communication module 2100. As with the communication module 2120, the further communication module 2220 may in particular be the communication module described above, for example in connection with FIGS. 1 and 2, as the first communication module (long-range communication module) 120, which is in particular set up to communicate with a low power WAN communication network. In connection with the second circuit board 2200, communication modules 2220 that can communicate with LTE-M or NB-IoT communication networks are particularly preferred.

The optional short-range communication module 2270, for example a Bluetooth module, may be the third communication module described above. The optional localisation module may be the localisation module 2230 described above, in particular a GPS module and/or a Glonass module and/or a Beidou module and/or a Galileo module.

The second base body 2200 may have a similar shape factor to the first base body 2100, i.e. it is longer than it is wide, for example at least twice as long as it is wide. For example, the length may be between 8 cm and 12 cm, preferably between 8 cm and 11.5 cm. In contrast, the second base body 2200 may be slightly wider than the first base body 2100. For example, the width can be between 3 cm and 6 cm, preferably between 4 cm and 5 cm. The above length and width ranges can be combined with each other as desired, i.e. the length can be between 8 cm and 12 cm and the width can be between 3 cm and 6 cm or between 4 cm and 5 cm, or the length can be between 8 cm and 11.5 cm and the width can be between 3 cm and 6 cm or between 4 cm and 5 cm.

The first circuit board 2100 and the second circuit board 2200 thus each have their own communication module, which corresponds to the first communication module or long-range communication module described above. Preferably, however, the communication module 2120 of the first circuit board 2100 and the further communication module 2220 of the second circuit board 2200 are set up for communication with different (low power WAN) communication networks. This allows the tracking device 2000, if it comprises the first and second circuit boards, to communicate with two different communication networks, which has a positive effect on the accessibility of the tracking device 2000 by the control unit 210 as well as on the position determination of the tracking device 2000. For example, the communication module 2120 of the first circuit board 2100 is set up for communication with LoRaWAN or Sigfox communication networks, and the further communication module 2220 of the second circuit board 2200 is set up for communication with LTE-M or NB-IoT communication networks. The further communication module 2220 of the second circuit board 2200 is thus also able to communicate with mobile radio networks, since LTE-M and NB-IoT are extensions of the LTE mobile radio network.

It is also possible that the further communication module 2220 is set up to communicate both with the communication network with which the communication module 2120 of the first circuit board 2100 also communicates, and to communicate with a further communication network.

In addition to the larger second rechargeable energy source 2250 and the further communication module 2220, the second circuit board 2200 may also differ from the first circuit board 2100 in the number and/or type of sensors 2280. For example, the second circuit board 2200 may include a sensor for sensing an environmental condition, such as a light sensor, and a sensor for sensing a motion condition, such as a rotation rate sensor and/or an acceleration sensor.

The first circuit board 2100 may therefore in particular have sensors 2180 for detecting one or more motion conditions, whereas the second circuit board 2200 may in particular have one or more sensors for detecting one or more motion conditions and one or more sensors for detecting one or more environmental conditions. An example of a jointly integrated humidity sensor, an air pressure sensor, a temperature sensor and a gas sensor is BME680 from Bosch. It is also possible that the first circuit board 2100 may have one or more sensors for sensing one or more motion conditions and one or more sensors for sensing one or more environmental conditions.

The first and second circuit boards 2100, 2200 can be electrically connected to each other in order to exchange data or for the purposes of power supply. In particular, the larger second energy source 2250 can also supply the first circuit board 2100 with energy.

The second circuit board 2200 may have a total weight that is greater than the total weight of the first circuit board 2100, wherein the weight of the second circuit board 2200 together with the first circuit board 2100 is not more than 40 g. As a result, the second rechargeable energy source 2250 may have a higher capacity than the first rechargeable energy source 2150, and the second circuit board 2200 may have more components compared to the first circuit board 2100, for example additionally a short-range communication module and a localisation module.

When the first and second circuit boards 2100, 2200 are electrically connected, one of the two processor modules may serve as a master module and the other as a slave module for controller and control of the entire tracking device 2000. Independently, each processor module controls/controls the components located on its circuit board, i.e., the first processor module 2140 controls/controls in particular the communication module 2120 and the sensors 2180, and the second processor module 2240 controls/controls the further communication module 2220 and the sensors 2280.

The first and second unique identifiers 2160, 2260 can, for example, each be an optically readable identifier, e.g. an alphanumeric code, a barcode or a QR code. The identifier is in each case unique for the respective circuit board, so that when the circuit boards are used separately as a tracking device, the tracking device formed in this way has a unique identifier for identification.

In particular, the tracking device 2000 does not have a graphic output unit. This further reduces the energy consumption and the dead weight of the tracking device 2000. In particular, the first circuit board 2100 is only equipped with components that enable tracking (communication module 2120) and registration of states of motion and environmental conditions (sensors 2180). As a result, a first energy source 2150 with a low weight can be used, so that the total weight of the tracking device 2000 is low and preferably below 10 g when only the first circuit board 2100 is used. It is thus also possible to track mail items, which is particularly advantageous for monitoring the entire dispatch process. In particular, the dispatch process of mail items can also be monitored for test purposes, for example to detect organisational or technical bottlenecks in the dispatch process.

For tracking larger/heavier letter mail items, e.g. compact letters, large letters or maxi letters, but also for parcels or other shipments, the tracking device 2000 can also be used with both circuit boards 2100, 2200 or only with the second circuit board 2200. As already explained above, each circuit board 2100, 2200 can be used independently as an independent tracking device 2000. The tracking device 2000 may therefore comprise the first circuit board 2100 alone, the second circuit board 2200 alone, or both circuit boards 2100, 2200.

In order to use both circuit boards 2100, 2200 together as a common tracking device 2000, the second circuit board 2200, or the second base body 2201 of the second circuit board 2100, can have a receptacle into which the first circuit board 2100 can be inserted. In this way, the electrical connection (data and power) can also be established at the same time.

By means of the tracking device 2000, shipments, in particular mail items, can be tracked. The method for tracking shipments by means of the tracking device 2000 essentially corresponds to the method already described above, for example explained in FIG. 3 or 4. Reference is therefore made below to the above explanations and only the differences are explained in more detail.

For tracking purposes, the tracking device 2000 may comprise only the first circuit board 2100, only the second circuit board 2200, or both circuit boards 2100, 2200 connected together. The following explanations apply to all variants.

Since the first and second circuit boards 2100, 2200 are each significantly longer than they are wide, the circuit boards can be inserted into a mail item in different orientations. Preferably, the length of the respective circuit boards 2100, 2200 is not greater than the ‘width’ of a letter. For example, a standard letter or compact letter from Deutsche Post has a width of 9 to 12.5 cm and a length of 14 to 23.5 cm. This makes it possible for the respective circuit board 2100, 2200 to be inserted into the mail item in such a way that its longitudinal orientation extends in the width direction of the mail item, i.e. it is inserted into the mail item on edge. This can reduce the bending load on the tracking device 2000. In order to determine, if necessary, the temporary bending which the mail item undergoes during the dispatch process from the user to the recipient, on the other hand, the tracking device 2000 is inserted with its longitudinal direction in the longitudinal direction of the mail item. To register the bend, for example, the bend sensor can only be activated when an acceleration is detected. This can save energy.

The tracking device 2000 is therefore suitably adapted for tracking mail items, i.e. it is thinner and even more flexible, and its external dimensions are even more compact than, for example, the tracking device of FIGS. 1 and 2. In addition, the tracking device 2000 is weight-optimised. In particular, it comprises two tracking devices, each of which can be used independently.

In addition to monitoring mail items, or other shipments, it is also of interest to monitor the entire dispatch process, for example to detect organisational or technical bottlenecks in the dispatch process. For this purpose, for example, test shipments can be sent by individual users, e.g. users 201, 202, 301, 302, 303 (see, for example, FIGS. 3 and 4), each of which has been enclosed with a tracking device 2000. For this purpose, a plurality of tracking devices 2000 are provided to the users 201, 202, 301, 302, 303, for example, by an operator 312. For tracking a shipment 230 from, for example, a first user 201, 302 to a recipient 211, 311, 312, 313, the tracking device 2000 is activated to send the activated tracking device 2000 together with the shipment 230 to the recipient 211, 311, 312, 313, wherein the activation of the tracking device 2000 is transmitted to the control unit 210, 310. This corresponds to the steps already described above.

During the transport of the shipment 230 to the recipient 211, 311, 312, 313, the control unit 210, 310 repeatedly receives the position of the activated tracking device 2000 in order to register the progress of the shipment. These steps also correspond to the steps already explained above.

As explained above, it is possible for the first user 201, 301, 302, 303 and/or the recipient 211, 311, 312, 313 to track the position of the shipment 230 via the control unit 210, 310.

Similarly, the control unit 210, 310 monitors the stock level of the tracking devices 2000 at some or all of the users 201, 202, 301, 302, 303, as explained above.

The control unit 210, 310 provides, after the tracking device 2000 together with the shipment 230 has arrived at the recipient 211, 311, 312, 313, destination address information for forwarding the tracking device 2000 to a second one of the plurality of users 201, 202, 301, 302, 303, wherein the recipient 211, 311, 312, 313 can retrieve the destination address information from the control unit 210, 310 using the unique identifier 2160, 2260 of the tracking device 2000. Thereby, as explained above, the control unit 210, 310 determines the destination address information depending on the demand for tracking devices 2000 by the users 201, 202, 301, 302, 303 and/or depending on the stock level of tracking devices 2000 at the users 201, 202, 301, 302, 303.

Since the tracking device 2000, unlike the tracking device 100, does not have a graphic output unit, the tracking device 2000 cannot display the destination address information directly. Therefore, destination instructions that cause destination address information to be displayed on the graphic output unit are not transmitted to the tracking device 2000. Instead, the control unit 210, 310 provides the destination address information which can be retrieved by the recipient 211, 311, 312, 313 using the unique identifier 2160, 2260 of the tracking device 2000 from the control unit 210, 310. For this purpose, the recipient 211, 311, 312, 313 can, for example, use an operator device 500, for example a mobile terminal such as a mobile phone, with which the unique identifier 2160, 2260 can be scanned or photographed. It is also possible for the recipient 211, 311, 312, 313 to enter the unique identifier 2160, 2260 into a query mask on a website, for example. Regardless of the way in which the unique identifier 2160, 2260 is entered, it serves to uniquely identify the tracking device 2000 to the control unit 210, 310, so that the control unit 210, 310 then outputs the destination address information provided for this tracking device 2000.

As already described above, for example in connection with FIGS. 3 and 4, the destination address information is determined by the control unit 210, 310, depending on the demand for tracking devices 2000 by the users 201, 202, 301, 302, 303 and/or depending on the stock level of tracking devices 2000 at the users 201, 202, 301, 302, 303.

The difference is therefore essentially to be seen in the fact that in the embodiments of FIGS. 3 and 4, the control unit 210, 310 transmits the destination instructions which cause the display of destination address information on the graphic output unit, whereas in the case of tracking by means of the tracking device 2000 without a graphic output unit, the control unit 210, 310 provides the destination address information which is then queried by the recipient 211, 311, 312, 313.

The recipient 211, 311, 312, 313 may, for example, print out the queried destination address information and affix it to a mailing envelope (e.g., an envelope) or place it in such an envelope (in the case of mailing envelopes with windows) or write it directly on a mailing envelope, place the tracking device 2000 in the mailing envelope and place it in a mailbox or place it in a reverse vending machine.

Since the tracking device 2000 is comparatively thin and bendable, the shipment tracked by the tracking device 2000 can also pass through typical mail distribution centres, including the sorting machines used there. The passage can be monitored and registered by means of the position determination by the communication module 2120 and/or the further communication module 2220, but also by means of the sensors 2180, 2280, for example the mechanical loads typically occurring during passage through a sorting machine, such as bending and acceleration. This makes it possible to recognise delays and problems in the dispatch process so that these problems can then be solved in a targeted manner.

Although specific embodiments are described above, the present invention is not limited thereto and can be suitably modified.

### REFERENCE LIST

100 tracking device
100a activated tracking device
101 base body
110 graphic output unit/display
120 communication module/long-range communication module
130 localisation module
140 processor module
150 energy source
160 identifier/machine-readable code
170 data communication module (short-range communication module/near-field communication module) Input and output device
180 sensor/sensors
190 memory module
195 optical display device/LED
201, 202 user
210 control unit
211 recipient
220 communication network
230 shipment
250 carrier
300 tracking device
301, 302, 303 user
310 control unit
311, 312, 313 recipient
321 operator
400 apparatus/magazine
410 tracking device
420 transport apparatus
430 charging device
500 mobile terminal
510 tracking device
710 tracking device
720 charging cable
730 data connection
800,805 transport container
810 tracking device
900 dispatch system
905 transport apparatus
910 tracking device
920b, 920c Bluetooth receiver-transmitter-unit
930 shipment
935 shipment identifier
940 printer, applicator
950 optical detection unit
1000, 1001 transport container
1010 tracking device
1012, 1013 transport goods
1020 Bluetooth receiver-transmitter-unit
A packing station
B parcel labelling station
C assignment station/verification station
2000 tracking shipment
2100 first circuit board
2101 first base body
2105 electrical connection
2120 communication module
2140 first processor module
2150 first rechargeable energy source
2160 first unique identifier
2180 sensors
2190 first memory module
2195 first optical display device
2200 second circuit board
2201 second base body
2220 further communication module
2230 localisation module
2240 second processor module
2250 second rechargeable energy source
2260 second unique identifier
2270 data communication module (short-range communication module/near-field communication module) Input and output device
2280 sensors
2290 second memory module
2295 second optical display device

1-25. (canceled)

26. A method for tracking shipments such as postal, parcel, package, forwarding and courier shipments, comprising:
providing each user of a plurality of users with at least one tracking device, in particular in each case a plurality of tracking devices, each of the tracking devices having a communication module and a graphic output unit and being configured to communicate wirelessly with a control unit independently of one another via the communication module;
activating, by a first one of the plurality of users, one of the tracking devices for use for tracking a shipment from the first user to a recipient, wherein the activation of the tracking device is transmitted to the control unit;
sending the activated tracking device together with the shipment from the first user to the recipient;
receiving repeatedly, by the control unit, the position of the activated tracking device during the transport of the shipment to the recipient;
the first user and/or the recipient being able to track the position of the shipment via the control unit;
monitoring, by the control unit, the stock level of the tracking devices at some or all of the users; and
transmitting, by the control unit, destination instructions to the activated tracking device, after said tracking device has arrived at the recipient together with the shipment, which destination instructions cause destination address information for forwarding the tracking device to a second one of the plurality of users to be displayed on the graphic output unit, wherein the control unit determines the destination instructions in dependence on at least one of the demand for tracking devices by the users and the stock level of tracking devices at the users.

27. The method according to claim 26, wherein activating the tracking device comprises supplying, by the first user, energy to the tracking device, in particular supplying energy without contact, and thereby transferring the tracking device from an idle state to an operating state.

28. The method according to claim 26, wherein activating the tracking device comprises performing one of the following steps, in particular by the first user:
actuating a switching element, for example a piezo element, a membrane switch or a pushbutton, of the tracking device;
feeding the tracking device to a charging device, for example by placing it on a charging device for contactless charging;
removing the tracking device from a charging device; and
removing or dispensing the tracking device from a magazine for storing a plurality of tracking devices.

29. The method according to claim 26, further comprising enabling the communication module to be in wireless connection with the control unit via a communication network, and querying repeatedly, by the control unit, the position of the activated tracking device with the communication network, which determines the position of the activated tracking device, wherein the communication network is in particular a low power WAN,
wherein optionally sending, by the activated tracking device, at least one data packet to the communication network so that the communication network can determine the position of the activated tracking device when the tracking device is moved or when a state of motion of the tracking device changes.

30. The method according to claim 26, wherein the tracking devices further each comprise a localisation module to determine the position of the tracking devices, wherein the determination of the position by the localisation module is independent of the determination of the position by the communication network, wherein the localisation module in particular comprises a GPS and/or a Glonass and/or a Beidou and/or a Galileo module.

31. The method according to claim 30, further comprising activating the localisation module when the activated tracking device reaches a predetermined area, and then the activated tracking device transmits its position determined by the activated localisation module to the control unit.

32. The method according to claim 26, wherein the tracking devices further each comprise a rechargeable energy source.

33. The method according to claim 26, wherein the tracking devices further each comprise a machine-readable code, each comprising a unique identifier, the method further comprising reading out, be thy first user, the machine-readable code and thus the unique identifier upon, before or after activation of the respective tracking device, wherein the unique identifier is optionally additionally also visible as human-readable writing on the respective tracking device.

34. The method according to claim 33, wherein the shipment has a unique shipment identifier, the method further comprising transmitting the shipment identifier and the unique identifier of the tracking device to the control unit and assigning to each other, thereby enabling the tracking of the shipment,
optionally cancelling the assignment of the shipment identifier and the unique identifier of the tracking device after the activated tracking device has arrived at the recipient together with the shipment.

35. The method according to claim 26, wherein the tracking devices further comprise a data communication module, for example a near-field communication module and/or a short-range communication module, to communicate contactlessly with an operator device, the method further comprising reading out, by the first user via the data communication module, the machine-readable code.

36. The method according to claim 26, further comprising providing, by an operator, the tracking devices to the users.

37. The method according to claim 26, further comprising, determining additionally the destination instructions, after receiving the shipment by the recipient, in dependence on the current location of the tracking device.

38. The method according to claim 26, further comprising transmitting, by the control unit, the destination instructions to the tracking device after the control unit has received a confirmation that a predetermined event or a sequence of at least two predetermined events has occurred,
optionally confirming, by the tracking device, that the event recognised by the tracking device has occurred.

39. The method according to claim 26, receiving regularly, by the control unit, the position of the tracking devices, in particular the position of the non-activated tracking devices, for monitoring the stock level of the tracking devices at the users.

40. The method according to claim 26, further comprising determining the destination instructions as a function of the geographical distribution of the users.

41. A method for tracking transport containers, comprising
providing each transport container of a plurality of transport containers with a tracking device, in particular detachably attached to the respective transport container, for use at different locations, the tracking devices each having a communication module and the tracking devices being configured to communicate wirelessly with a control unit independently of one another via the communication module, and the transport containers being configured to receive one or more transport goods;
sending, by using at least some of the transport containers, transport goods between the locations, at least one transport container holding at least one transport good which is sent from one location to another location by means of the transport container;
repeatedly transmitting the position of the tracking devices attached to the transport containers and thus of the transport containers to the control unit during the transport of the transport containers between the locations;
tracking, via the control unit, the position of the tracking devices attached to the transport containers, and thus the position of the transport containers during transport of the transport goods;
monitoring, by the control unit, the stock level of the tracking devices and thus of the transport containers at some or all locations;
generating, by the control unit, instructions for sending empty transport containers without transport goods between the locations in dependence on the demand for transport containers at the individual locations and/or in dependence on the stock level of transport containers at the individual locations; and
sending the empty transport containers between the locations on the basis of the instructions generated by the control unit.

42. The method according to claim 41, further comprising at least one of the following:
the tracking devices each comprising a graphic output unit, the control unit transmitting destination instructions to the tracking devices, which destination instructions causing destination address information for sending the empty transport containers with the respective tracking device to another location to be displayed on the graphic output unit, the control unit determining the destination instructions as a function of the demand for transport containers at the individual locations and/or as a function of the stock level of transport containers at the individual locations;
the tracking devices each having a data communication module, for example a near-field communication module and/or a short-range communication module, in order to communicate contactlessly with an operator device, the control unit transmitting destination instructions to the tracking device, which destination instructions can be read out contactlessly by means of the operator device via the data communication module and cause, on the operator device, the output of destination address information for sending the empty transport containers with the tracking device to other locations, the control unit determining the destination instructions in dependence on the demand for transport containers at the individual locations and/or in dependence on the stock level of transport containers at the individual locations; and
the tracking devices each having a data communication module, for example a near-field communication module and/or a short-range communication module, configured to communicate with receiver-transmitter-units distributed at the individual locations for determining the position of the tracking devices, and thus for determining the position of the transport containers, the positions of transport containers being determined by means of the receiver-transmitter-units and transmitted to the control unit, the control unit checking on the basis of the determined positions whether empty transport containers have been provided for sending and/or have already been sent in accordance with the instructions generated by the control unit.

43. A method for tracking shipments such as postal, parcel, package, forwarding and courier shipments, comprising:
providing each user of a plurality of users with at least one tracking device, in particular a plurality of tracking devices in each case, which each have a communication module and an identifier which is unique for the respective tracking device and which can communicate wirelessly with a control unit independently of one another via the communication module, wherein
activating, by a first one of the plurality of users, one of the tracking devices for use to track a shipment from the first user to a recipient;
transmitting the activation of the tracking device to the control unit;
sending the activated tracking device together with the shipment to the recipient;
repeatedly receiving, by the control unit, the position of the activated tracking device during the transport of the shipment to the recipient;
the first user and/or the recipient being able to track the position of the shipment via the control unit;
monitoring, by the control unit, the stock level of the tracking devices at some or all of the users; and
providing, by the control unit, after the tracking device has arrived with the shipment at the recipient, destination address information for forwarding the tracking device to a second one of the plurality of users, the recipient being enabled to retrieve the destination address information using the unique identifier of the tracking device from the control unit, wherein the control unit determines the destination address information in dependence on the demand for tracking devices by the users and/or in dependence on the stock level of tracking devices at the users.

44. The method according to claim 43, wherein the recipient is enabled to query the unique identifier by means of an operator device and the querying of the destination address information is performed by the control unit via the operator device.
